(19) United States
(12) Patent Application Publication
(10) Pub. No.: US 2002/0052790 A1
(43) Pub. Date: May 2, 2002

(54) Server and terminals used in management system for serving food and beverage

(75) Inventor: Shigeki Tomishima, Hyogo (JP)

Correspondence Address: McDERMOTT, WILL & EMERY, 600 13th Street, N.W., Washington, DC, 20005-3096, US

(73) Assignee: Mitsubishi Denki Kabushiki Kaisha

(21) Appl. No.: 09/912,331

(22) Filed: Jul. 26, 2001

(30) Foreign Application Priority Data
Oct. 30, 2000 (JP) 2000-329923 (P)
Dec. 28, 2000 (JP) 2000-400563 (P)

(51) Int. Cl. G06F 17/60

(52) U.S. Cl. 705/15; 705/5

(57) ABSTRACT

A restaurant management system includes: order terminals placed on respective tables and to each of which a guest inputs an order; a serving terminal to which an employee inputs completion of cooking; a kitchen terminal installed in a kitchen and a server connected to the terminals. The server includes a communication circuit and a control circuit. The communication circuit includes a circuit receiving order information from an order terminal and a circuit receiving completion information indicating completion of cooking from the serving terminal. The control circuit includes a circuit transmitting warning information that a predetermined time has elapsed till said control circuit receives completion information after said control circuit received order information.

### BACKGROUND OF THE INVENTION

1. Field of the Invention

The present invention relates to a management system for setting food whose order has been received from a guest, followed by having a meal on a table in a restaurant or the like and particularly, to a management system in which food is ordered, is cooked and set on a table with as small a number of employees as possible.

2. Description of the Background Art

When someone has a meal in a restaurant, he/she orders it to an attendant. The attendant inputs the order to a portable terminal. The portable terminal prints out a bill. When all items of the food are set prepared and carried to the table, the attendant hands over the bill to the guest. After finishing the meal, the guest pays the bill at a cashier.

In such a system, the guest sometimes experiences a waiting time before an attendant comes to the table to take an order. Sometimes he/she may experience a trouble caused by human errors such as mishearing or the like by the attendant. Furthermore, the guest may experience another waiting time at a cashier caused by the payment process.

In order to solve such a problem, a restaurant ordering/accounting system has been disclosed in Japanese Patent Laying-Open No. 5-298334(1993). The system includes an ordering/accounting device placed on each table in a restaurant and a printing device installed in a kitchen of the restaurant. The printing device includes a receive circuit receiving an order data from the ordering/accounting device and a printing circuit printing on a slip on the basis of received order data. The ordering/accounting device includes: a card reader capable of reading an ID (identification) card allowing a cash withdrawal from a bank account; a check circuit confirming authenticity of the ID card read out; an input circuit inputting food items ordered by input with a number key; and an accounting circuit performing accounting on the basis of the ID card.

According to the system, reception of an order, and issuance and payment of a bill are performed by an ordering/accounting device rather than by attendants; therefore, personnel expenses can be reduced, troubles caused by a human mistake are decreased and further, a waiting time can be reduced.

In this system, however, the guest still experiences a waiting time after ordering before the ordered meal is carried to the guest's table. Furthermore, this system cannot reduce a time an arriving guest will experience before he/she is ushered to an unseated table as attendant is necessary for leading the guest to a table. Still furthermore, this system cannot prevent improper accounting, in which case the restaurant side suffers a money loss.

### SUMMARY OF THE INVENTION

It is accordingly an object of the present invention to provide a server and a terminal for use in a management system for serving food and beverage, and in which a waiting time before the ordered meal is served can be reduced to the shortest possible level.

It is another object of the present invention to provide a server and a terminal for use in a management system for serving food and beverage, and in which a waiting time before the ordered meal is cooked in a kitchen can be reduced to the shortest possible level.

It is a further object of the present invention to provide a server and a terminal for use in a management system for serving food and beverage, and in which waiting times can be individually reduced for respective different kinds of cooking even if a cooking time is different according a kind of cooking.

It is still another object of the present invention to provide a server and a terminal for use in a management system for serving food and beverage, and capable of helping a guest to find an unseated table in a short time after arriving at a restaurant.

It is yet another object of the present invention to provide a server and a terminal for use in a management system for serving food and beverage, and capable of surely receiving a charge for served food.

It is a still further object of the present invention to provide an order terminal and a serving terminal for use in a management system for serving food and beverage, and in which a waiting time before the ordered meal is served can be reduced to the shortest possible level without a server.

A server relating to the present invention is used in a management system for serving food and beverage in a restaurant installed with a plurality of tables and serving a guest with cooked food and beverage. This system includes: a server; a serving terminal; and a plurality of order terminals. An order terminal is placed on each of tables and transmits order information inputted by a guest to the server. The serving terminal transmits completion information indicating completion of cooking and inputted by an employee of the restaurant to the server. The serving terminal receives warning information from the server and displays it. The server includes: a communication circuit performing communication with the plurality of order terminals and the serving terminal; and a control circuit connected to the communication circuit. The control circuit includes: a circuit detecting a time point at which order information is received from an order terminal; and a circuit generating warning information that a predetermined time has elapsed till completion information is received from the serving terminal after the order information was received to transmit the generated warning information to the serving terminal.

According to the system, can be displayed on the serving terminal is a warning that a cooking has not been completed even when a predetermined time (for example, an average cooking time) elapses after a guest placed an order for a food item using the order terminal. An employee in charge of setting the food item on a table can ask an employee in charge of cooking to accelerate cooking of the food item when the employee in charge of the table setting sees the serving terminal on which the warning is displayed. Thereby, a waiting time of the guest can be reduced to the shortest possible level.

An order terminal relating to the present invention is used in a management system for serving food and beverage in a restaurant installed with a plurality of tables and serving a guest with cooked food and beverage. The system includes: a server; a serving terminal; and a plurality of order terminals. The serving terminal transmits completion information indicating completion of cooking and inputted by an employee of a restaurant to the server. The server generates warning information that a predetermined time has elapsed till completion information is received from the serving terminal after the order information was received from an order terminal to transmit the generated warning information to the serving terminal. The serving terminal displays the warning information received from the server. The order terminal includes: a communication circuit placed on each table and communicates with the server; an input circuit to which a guest inputs order information expressing a food item that a guest desires; and a control circuit connected to the communication circuit and the input circuit. The control circuit includes a circuit transmitting the order information to the server.

According to the system, can be displayed on the serving terminal is a warning that a cooking has not been completed even when a predetermined time (for example, an average cooking time) elapses after a guest placed an order for a food item using the order terminal. An employee in charge of setting the food item on a table can ask an employee in charge of cooking to accelerate cooking of the food item when the employee in charge of the table setting sees the serving terminal on which the warning is displayed. Thereby, a waiting time of the guest can be reduced to the shortest possible level.

A serving terminal relating to the present invention is used in a management system for serving food and beverage in a restaurant with a plurality of tables and serving a guest with cooked food and beverage. The system includes: a server; a serving terminal and a plurality of order terminals. An order terminal is placed on each table and transmits order information inputted by a guest to the server. The server generates warning information that a predetermined time has elapsed till completion information is received from the serving terminal after the order information was received from the order terminal to transmit the generated warning information to the serving terminal. The serving terminal includes: a communication circuit communicating with the server; a display circuit displaying information; an input circuit to which an employee of a restaurant inputs completion information indicating completion of cooking of an ordered food item; and a control circuit connected to the communication circuit, the display circuit and the input circuit. The control circuit of the serving terminal includes a circuit transmitting completion information inputted using the input circuit of the serving terminal to the server; and a circuit controlling the display circuit so as to display warning information received from the server.

According to the system, the serving terminal can display a warning that a cooking has not been completed even when a predetermined time (for example, an average cooking time) elapses after a guest placed an order for a food item using the order terminal. An employee in charge of setting the food item on the table can ask an employee in charge of cooking to accelerate cooking of the food item when the employee in charge of the table setting sees the serving terminal on which the warning is displayed. Thereby, a waiting time of the guest can be reduced to the shortest possible level.

A management system for serving food and beverage further includes: a kitchen display terminal installed in a kitchen and displaying a warning information received from a server. The control circuit of the server further includes: a circuit transmitting the warning information to the kitchen terminal.

With such a configuration adopted, the kitchen display terminal can display a warning that a cooking has not been completed even when a predetermined time elapses after a guest placed an order for a food item using an order terminal. An employee in charge of cooking the food item in the kitchen can accelerate cooking of the food item to reduce a waiting time to the shortest possible level.

A kitchen display terminal relating to the present invention is used in a management system for serving food and beverage in a restaurant with a plurality of tables and serving a guest with cooked food and beverage. The system includes: a server; a serving terminal; and a plurality of order terminals. An order terminal is placed on each table and transmits order information inputted by a guest to the server. The serving terminal transmits completion information indicating completion of cooking and inputted by an employee of a restaurant to the server. The server transmits warning information that a predetermined time has elapsed till completion information is received from the serving terminal after the order information was received from the order terminal to the kitchen display terminal. The kitchen display terminal includes: a communication circuit installed in a kitchen and communicating with the server; a display circuit displaying information; and a control circuit connected to a receive circuit and a display circuit and controlling the display circuit so as to display warning information received from the server.

With such a configuration adopted, the kitchen display terminal can display a warning that a cooking has not been completed even when a predetermined time elapses after a guest placed an order for a food item using the order terminal. An employee in charge of cooking the food item in the kitchen can accelerate cooking of the food item to reduce a waiting time to the shortest possible level.

The server may further includes: a storage circuit storing a predetermined time for each kind of cooking.

With such a configuration adopted, the serving terminal can display a warning that a cooking has not been completed even when a predetermined time for each food item ordered has elapses.

A management system for serving food and beverage further includes an occupied seat display terminal. An order terminal further includes a receipt circuit receiving a charge on an ordered food item. An order terminal transmits that receipt of a charge by the receipt circuit can be effected to the server prior to transmission of the order information. The occupied seat display terminal displays an occupied seat state at each table on the basis of occupied seat information received from the server. The control circuit of the sever further includes a circuit responding to information that receipt of a charge can be effected by the receipt circuit to transmit occupied seat information indicating that a table of interest is seated to the occupied seat display terminal.

The occupied seat display terminal displays occupied seat information of a restaurant. A guest visiting the restaurant can find out a table on which no occupied seat information is displayed with ease. With the terminal adopted, no necessity arises for a time in which a guest searches for an unseated table or is ushered to an unseated table, thereby enabling a waiting time that a guest suffers from arrival till placing an order to decrease.

An occupied seat display terminal relating to the present invention is used in a management system for serving food and beverage in a restaurant with a plurality of tables and serving a guest with cooked food and beverage. The system includes: a server; an occupied seat display terminal; and a plurality of order terminals. An order terminal is placed on each table and includes a receipt circuit receiving a charge on an ordered food item. The order terminal transmits that receipt of a charge can be effected by the receipt circuit to the sever. The server responds to information that receipt of the charge can be effected by the receipt circuit of the order terminal to transmit occupied seat information indicating that a table of interest is seated to the occupied seat display terminal. The occupied seat display terminal includes: a communication circuit communicating with the server; and a display circuit connected to the communication circuit and displaying an occupied seat state of each table on the basis of the occupied seat information received from the server.

The occupied seat display terminal displays occupied seat information of a restaurant. A guest visiting the restaurant can find out a table on which no occupied seat information is displayed with ease. With the terminal adopted, no necessity arises for a time in which a guest searches for an unseated table or is ushered to an unseated table, thereby enabling a waiting time that a guest suffers from arrival till placing an order to decrease.

An order terminal transmits limit information for calculating an amount of money that a guest can use at a table of interest prior to transmission of order information. The serving terminal displays warning information to a balance received from the server. The server further includes: a storage circuit storing prices of food items. The control circuit of the server further includes: a circuit calculating an amount of money that a guest can use on the basis of limit information received from an order terminal of each table; a circuit reading out a price of an ordered food item from the storage circuit; and a circuit transmitting warning information to a balance at a table of interest to the serving terminal when an amount of money obtained by subtracting a price of a food item read out from an amount of money that a guest can use is less than a predetermined amount.

The server calculates an amount of money that the guest at the table of interest can use in advance and subtracts a price of a food item ordered by the guest from the amount of money the guest can use. The server transmits a warning to a balance to the serving terminal when a calculated balance is less than the predetermined amount (for example, the lowest food unit price among food unit prices of food items) Thereby, an employee can obtain knowledge that the guest has a small balance.

An order terminal relating to the present invention is used in a management system for serving food and beverage in a restaurant with a plurality of tables and serving the guest with cooked food and beverage. The system includes: a serving terminal; and a plurality of order terminals. The serving terminal displays order information received from an order terminal and completion information indicating completion of a food item inputted by an employee of a restaurant. An order terminal includes: an input circuit placed on each table and to which a guest inputs order information; and a transmit circuit transmitting an order information to the serving terminal.

The serving terminal displays order information inputted by a guest and completion information indicating completion of cooking. An employee in charge of table setting can extract order information on a food item whose completion information has not been displayed even when an average cooking time elapses after the order information was displayed. An employee in charge of table setting can ask an employee in charge of cooking in a kitchen to accelerate cooking of the food item on the basis of the extracted order information. Thereby, a waiting time of a guest can be reduced to the shortest possible level.

The serving terminal relating to the present invention is used in a management system for serving food and beverage in a restaurant with a plurality of tables and serving the guest with cooked food and beverage. The system includes: a serving terminal; and a plurality of order terminals. An order terminal is placed on each table and transmits order information inputted by a guest to the serving terminal. The serving terminal includes: a receive circuit receiving order information supplied from an order terminal; a display circuit displaying information; an input circuit to which an employee of a restaurant inputs completion information indicating completion of cooking of ordered food item; and a control circuit connected to the receive circuit, the display circuit and the input circuit. The control circuit includes: a circuit controlling the display circuit so as to display order information received from an order terminal; and a circuit controlling the display circuit so as display completion information inputted using the input circuit of the serving terminal.

Serving terminal displays order information inputted by the guest and completion information indicating completion of cooking. An employee in charge of the table setting can extract order information on a food item whose completion information has not been displayed even when an average cooking time elapses after the order information was displayed. An employee in charge of the table setting can ask an employee in charge of cooking in a kitchen to accelerate cooking of the food item on the basis of the extracted order information. Thereby, a waiting time of a guest can be reduced to the shortest possible level.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a drawing representing a configuration of all of a restaurant management system relating to a first embodiment of the present invention;

FIG. 2 is a control block diagram of an order terminal relating to the first embodiment of the present invention;

FIG. 3 is a control block diagram of a serving terminal relating to the first embodiment of the present invention;

FIG. 4 is a control block diagram of a kitchen display terminal relating to the first embodiment of the present invention;

FIG. 5 is a representation of an appearance of a computer realizing a server relating to the first embodiment of the present invention;

FIG. 6 is a control block diagram of a computer realizing a server relating to the first embodiment of the present invention;

FIG. 7 is a control block diagram of an unoccupied seat display terminal relating to the first embodiment of the present invention;

FIG. 8 is a drawing representing a structure of balance data transmitted from an order terminal to a server relating to the first embodiment of the present invention;

FIG. 9 is a drawing representing a structure of authentication request data transmitted from an order terminal to a server relating to the first embodiment of the present invention;

FIG. 10 is a drawing representing a structure of authentication data transmitted from a server to an order terminal relating to the first embodiment of the present invention;

FIG. 11 is a drawing representing a structure of order data transmitted from an order terminal to a server relating to the first embodiment of the present invention;

FIG. 12 is a drawing representing a structure of order confirmation data transmitted from a server to an order terminal relating to the first embodiment of the present invention;

FIG. 13 is a drawing representing a structure of cooking time data transmitted from a server to an order terminal relating to the first embodiment of the present invention;

FIG. 14 is a drawing representing a structure of payment request data transmitted from an order terminal to a server relating to the first embodiment of the present invention;

FIGS. 15 and 16 are drawings each representing structures of payment confirmation data transmitted from a server to an order terminal relating to the first embodiment of the present invention;

FIG. 17 is a table representing a structure of order data classified by table stored on a fixed disk of a server relating to the first embodiment of the present invention;

FIG. 18 is a table representing a structure of table status data stored on a fixed disk of a server relating to the first embodiment of the present invention;

FIG. 19 is a table representing a structure of delay limit data stored on a fixed disk of a server relating to the first embodiment of the present invention;

FIG. 20 is a table representing a structure of totalized order data stored on a fixed disk of a server relating to the first embodiment of the present invention;

FIG. 21 is a flow chart representing overall processing performed at an order terminal relating to the first embodiment of the present invention;

FIG. 22 is a flow chart representing card authentication processing shown in FIG. 21;

FIG. 23 is a flow chart representing order processing shown in FIG. 21;

FIG. 24 is a flow chart representing payment processing shown in FIG. 21;

FIG. 25 is a flow chart representing authentication processing performed in a server relating to the first embodiment of the present invention;

FIG. 26 is a flow chart representing order processing performed in a server relating to the first embodiment of the present invention;

FIG. 27 is a flow chart representing delay detection processing performed in a server relating to the first embodiment of the present invention;

FIG. 28 is a flow chart representing calculation processing for a cooking time performed in a server relating to the first embodiment of the present invention;

FIG. 29 is a flow chart representing payment processing performed in a server relating to the first embodiment of the present invention;

FIG. 30 is a flow chart representing unoccupied seat processing performed in a server relating to the first embodiment of the present invention;

FIG. 31 is a flow chart representing analysis processing performed in a server relating to the first embodiment of the present invention;

FIG. 32 is a flow chart representing display processing performed in a kitchen display terminal relating to the first embodiment of the present invention;

FIG. 33 is a flow chart representing input processing performed in a serving terminal relating to the first embodiment of the present invention;

FIG. 34 is a flow chart representing display processing performed in a serving terminal relating to the first embodiment of the present invention;

FIG. 35 is a flow chart representing display processing performed in an unoccupied seat display terminal relating to the first embodiment of the present invention;

FIGS. 36 to 44 are display examples on a display section of an order terminal relating to the first embodiment of the present invention;

FIG. 45 is a display example on a display section of a serving terminal relating to the first embodiment of the present invention;

FIG. 46 is a display example on a display section of a kitchen display terminal relating to the first embodiment of the present invention;

FIG. 47 is a display example on a display section of an unoccupied seat display terminal relating to the first embodiment of the present invention;

FIG. 48 represents an overall configuration of a restaurant management system relating to a second embodiment of the present invention;

FIG. 49 represents a structure of reception request data transmitted from an order terminal to a server relating to the second embodiment of the present invention;

FIG. 50 represents a structure of reception completion data transmitted from a server to an order terminal relating to the second embodiment of the present invention;

FIG. 51 represents a structure of a reception disable data transmitted from a server to an order terminal relating to the second embodiment of the present invention;

FIG. 52 represents a structure of a reservation data transmitted from a central server to a server relating to the second embodiment of the present invention;

FIG. 53 represents a structure of reservation failure data transmitted from a server to a central server relating to the second embodiment of the present invention;

FIG. 54 is a table representing a structure of table status data stored on a fixed disk of a central server relating to the second embodiment of the present invention;

FIG. 55 is a flow chart representing overall processing performed in an order terminal relating to the second embodiment of the present invention;

FIG. 56 is a flow chart representing reception processing performed in a server relating to the second embodiment of the present invention;

FIG. 57 is a flow chart representing display processing performed in an unoccupied seat display terminal relating to the second embodiment of the present invention;

FIG. 58 is a flow chart representing transmission processing performed in a server relating to the second embodiment of the present invention;

FIG. 59 is a flow chart representing unoccupied seat response processing performed in a central server relating to the second embodiment of the present invention;

FIG. 60 is a flow chart representing reservation processing performed in a central server relating to the second embodiment of the present invention;

FIG. 61 is a flow chart representing reservation processing performed in a server relating to the second embodiment of the present invention;

FIG. 62 is a flow chart representing reservation control processing performed in a server relating to the second embodiment of the present invention;

FIG. 63 is a flow chart representing reception processing performed in a central server relating to the second embodiment of the present invention;

FIGS. 64 to 67 are display examples displayed on a portable telephone relating to the second embodiment of the present invention;

FIG. 68 is a display example displayed on a display section of an unoccupied seat display terminal relating to the second embodiment of the present invention; and

FIG. 69 is a display example displayed on a display section of an order terminal relating to the second embodiment of the present invention.

### DESCRIPTION OF THE PREFERRED EMBODIMENTS

Description will be given of embodiments of the present invention below with reference to the accompanying drawings. In the following description, the same constituents are indicated by the same symbols. Constituents with the same symbols are the same as each other in not only name but also function; therefore, detailed descriptions thereof will not be repeated.

First Embodiment

A restaurant management system relating to the present invention is a system managing from ordering to table setting in a restaurant serving a guest with cooked food. The restaurant with the system has many tables.

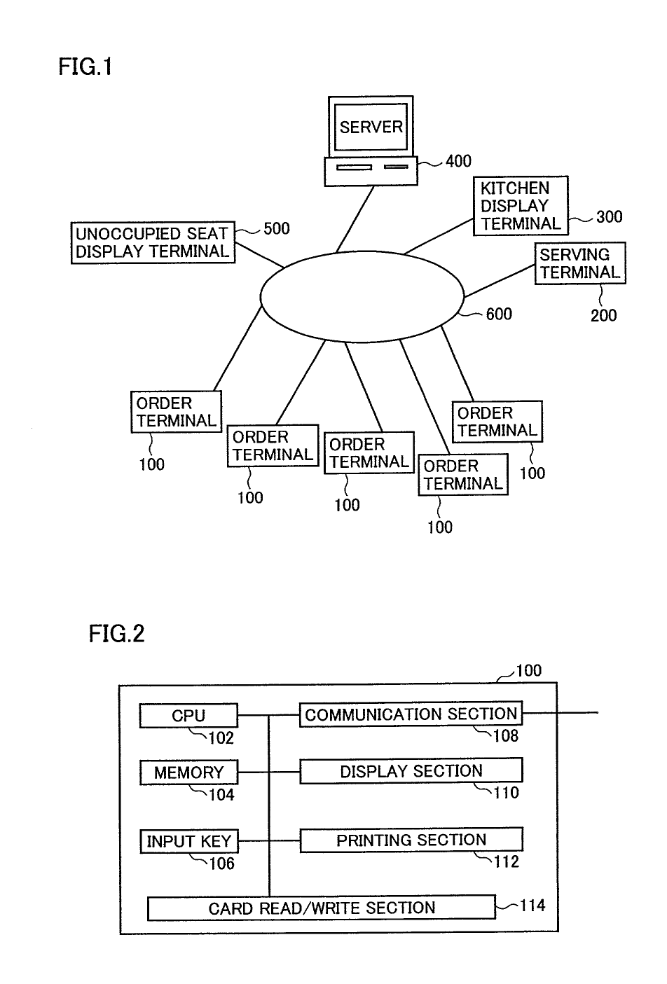

Referring to FIG. 1, the restaurant management system includes: order terminals 100 placed on respective tables; a table-setting terminal 200 installed such that employees in charge of table setting can see it; a kitchen display terminal 300 installed such that employees in charge of cooking can see it; a server 400 controlling all of the restaurant management system; and an unoccupied seat display terminal 500 installed at an entrance of the restaurant. The server and the terminals are connected to each other through a network 600.

Note that it is allowed that the table-setting terminal 200 is functionally realized by the server 400 and the server 400 with a display monitor is installed such that employees in charge of table setting can see it instead of the serving terminal 200.

Referring to FIG. 2, the order terminal 100 relating to the present invention includes: a CPU (Central Processing Unit) 102 controlling all of the order terminal 100; a memory 104 storing a program executed in the CPU 102, intermediate data of the program and others; an input key 106 with which a guest inputs a food item ID and whether or not the guest needs a payment request and a receipt; a communication section 108 connected to the network 600 and communicating with the server 400; a display section 110 displaying a name of a food item, an average cooking time thereof and others corresponding to a food item ID in response to that the food item ID has been inputted from the input key 106; a printing section 112 printing a receipt; and a card read/write section 114 performing charge processing using a prepaid card or a credit card.

The card read/write section 114 has a construction in which once a prepaid card or a credit card is inserted thereinto, the card is never released out unless a payment request button is pushed down from the input key 106 and the card read/write section 114 receives payment confirmation data from the server 400 through the communication section 108.

The card read/write section 114 reads a password number and balance data stored as magnetic data in a prepaid card itself when the prepaid card is inserted. Only when the password number thus read out coincides with a password number inputted from the input key 106, a guest is entitled to place an order for food. After payment, the card read/write section 114 writes new balance data received from the server 400 through the communication section 108 to the prepaid card.

The card read/write section 114 reads a card number stored as a magnetic data in a credit card when the credit card is inserted. The order terminal 100 transmits a password number inputted from the input key 106 by a user of the credit card and a card number read out with the card read/write section 114 to the server 400 through the communication section 108.

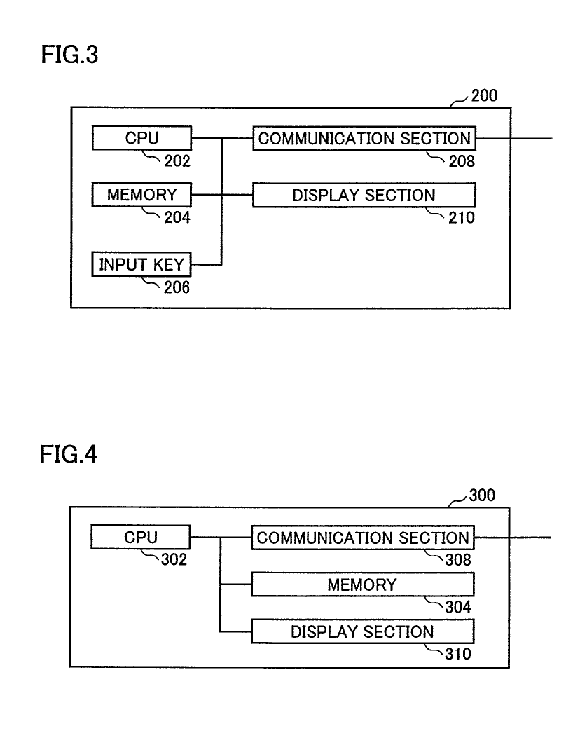

Referring to FIG. 3, the serving terminal 200 includes: a CPU 202 controlling all of the serving terminal 200; a memory 204 storing a program executed in the CPU 202, intermediate data thereof and others; an input key 206 inputting completion information indicating that cooking of an ordered food has been completed, client data (male or female and an age bracket) at each table and other data; a communication section 208 communicating with the server 400 through the network 600; and a display section 210 displaying information on ordered food items, warning information indicating delay of an ordered food item for each table and others. Note that in the following description, it is assumed that the input key 206 is realized as a touch panel constructed in one body with the display section 210.

Referring to FIG. 4, the kitchen display terminal 300 relating to the present embodiment includes: a CPU 302 controlling all of the kitchen display terminal 300; a memory storing a program executed in the CPU 302, intermediate data thereof and others; a communication section 308 communicating with the server 400 through the network 600; and a display section 310 displaying ordered food items classified by kind of cooking. In the display sections 310, an overwrite processing is performed on the basis of data received from the server 400 through the communication section 308. Since only data of food items not completed in regard to cooking is transmitted from the server 400, no display of food items for which cooking have been completed is presented.

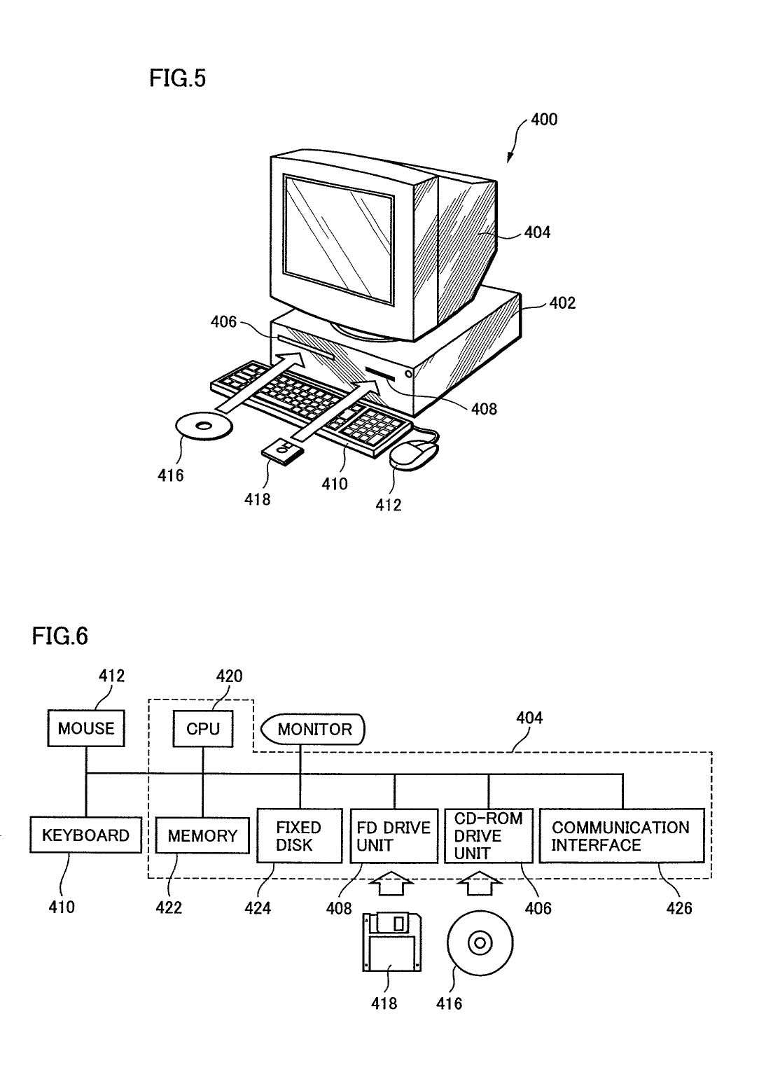

The server 400 is actually realized by a software running on a computer such as a personal computer or a workstation. FIG. 5 shows an appearance of a computer system as an example of a server. Referring to FIG. 5, the computer system includes: a computer 402 having an FD (Flexible Disk) drive unit 408 and a CD-ROM (Compact Disc-Read Only Memory) drive unit 406; a monitor 404; a keyboard 410 and a mouse 412.

FIG. 6 shows a block diagram of a structure of the computer. As shown in FIG. 6, the computer 402 includes in addition to the FD drive unit 408 and the CD-ROM drive unit 406: a CPU 420 mutually connected to other constituents by a bus; a memory 422; a fixed disk 424 and a communication interface 426. An FD 418 is mounted to the FD drive unit 408. A CD-ROM 416 is mounted to the CD-ROM drive unit 406.

The server 400 is functionally realized by a software executed by such a computer hardware and the CPU 420. Generally speaking, such a software is distributed on the market stored on a recording medium such as the FD 418, the CD-ROM 416 or the like, read out from the recording medium by the FD drive unit 408, the CD-ROM drive unit 406 or the like and stored onto the fixed disk 424. Furthermore, the software is read out from the fixed disk 424 to the memory 422 and executed by the CPU 420.

Since hardware itself of the computer shown in FIGS. 5 and 6 is commonly used; detailed description thereof will not be repeated here.

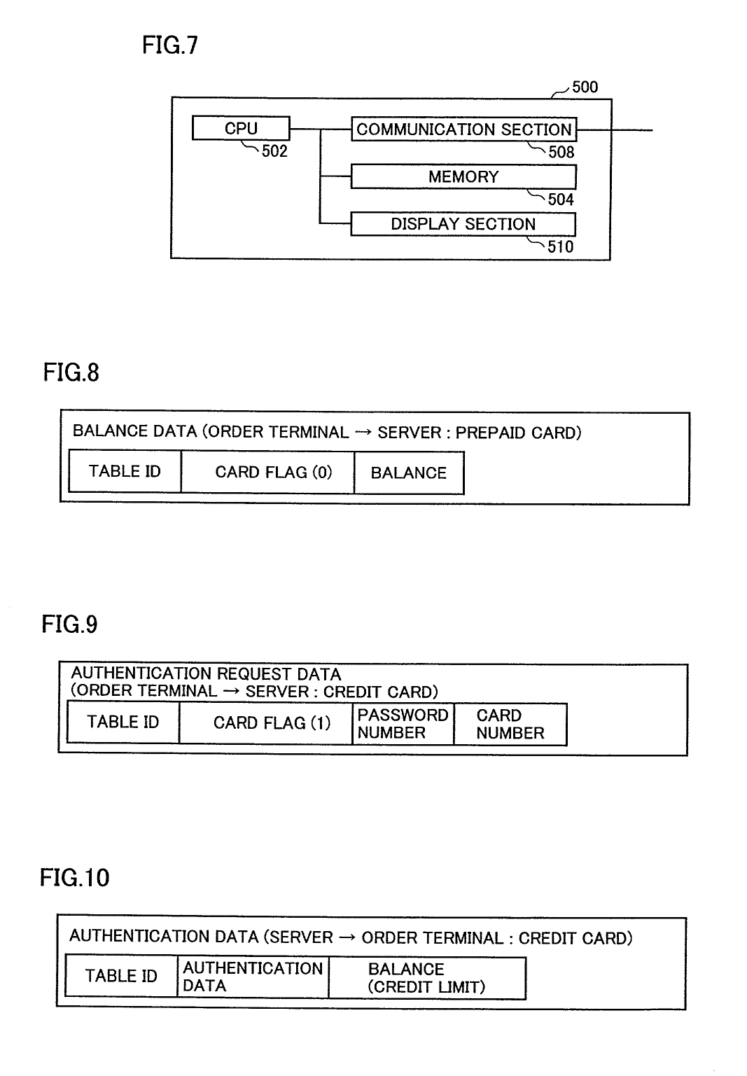

Referring to FIG. 7, the unoccupied display terminal 500 relating to the present embodiment includes a CPU 502 controlling all of the unoccupied display terminal 500; a memory 504 storing a program executed in the CPU 502, intermediate data thereof and others; a communication section connected to the network 600 and communicating with the server 400; and a display section 510 displaying unoccupied seat information so as to correspond to a layout of tables of the restaurant. The unoccupied seat information displayed on the display section 510 is classified into three kinds including “an unoccupied seat state,” “an occupied seat state” and “a near unoccupied seat state.” In “the unoccupied seat state,” neither a prepaid card nor a credit card is inserted in the card read/write section 144. In “the occupied seat state,” a prepaid card or a credit card is inserted in the card read/write section 114 but a payment request button is not pushed down. In “the near unoccupied seat state,” a prepaid card or a credit card is inserted in the card read/write section 114 and a payment request button has been pushed down.

Referring to FIG. 8, balance data is transmitted from the order terminal 100 to the server 400 if a card inserted in the card read/write section 114 of the order terminal 100 is a prepaid card. The balance data includes a table ID (Identification) for uniquely specifying a table of interest in the restaurant, a card flag indicating that an inserted card is a prepaid card; and a balance of the card.

Referring to FIG. 9, authentication request data is transmitted from the order terminal 100 to the server 400 if a card inserted in the card read/write section 114 of the order terminal 100 is a credit card. Authentication request data includes: a table ID; a card flag indicating that a card in use is a credit card; a password number inputted from the input key 106; and a card number of the credit card read out in the card read/write section 114. As shown in FIGS. 8 and 9, a kind of a card can be identified by a card flag.

Referring to FIG. 10, authentication data is transmitted from the server 400 to the order terminal 100 if a card read out in the card read/write section 114 is a credit card. The authentication data includes: a table ID; authentication data; and a balance (a credit limit up to which payment can be effected with a credit card). The server 400 specifies a credit company on the basis of a card number in response to that the server 400 has received authentication request data shown in FIG. 9 from the order terminal 100. The server 400 performs an authentication request to a sever of the specified credit company and receives authentication completion data from the server of the specified credit company. The server 400 transmits the authentication data shown in FIG. 10 to the order terminal 100 who has transmitted the authentication request to the server 400 when receiving the authentication completion data. The server 400 receives data expressing a credit limit up to which payment can be effected with a credit card.

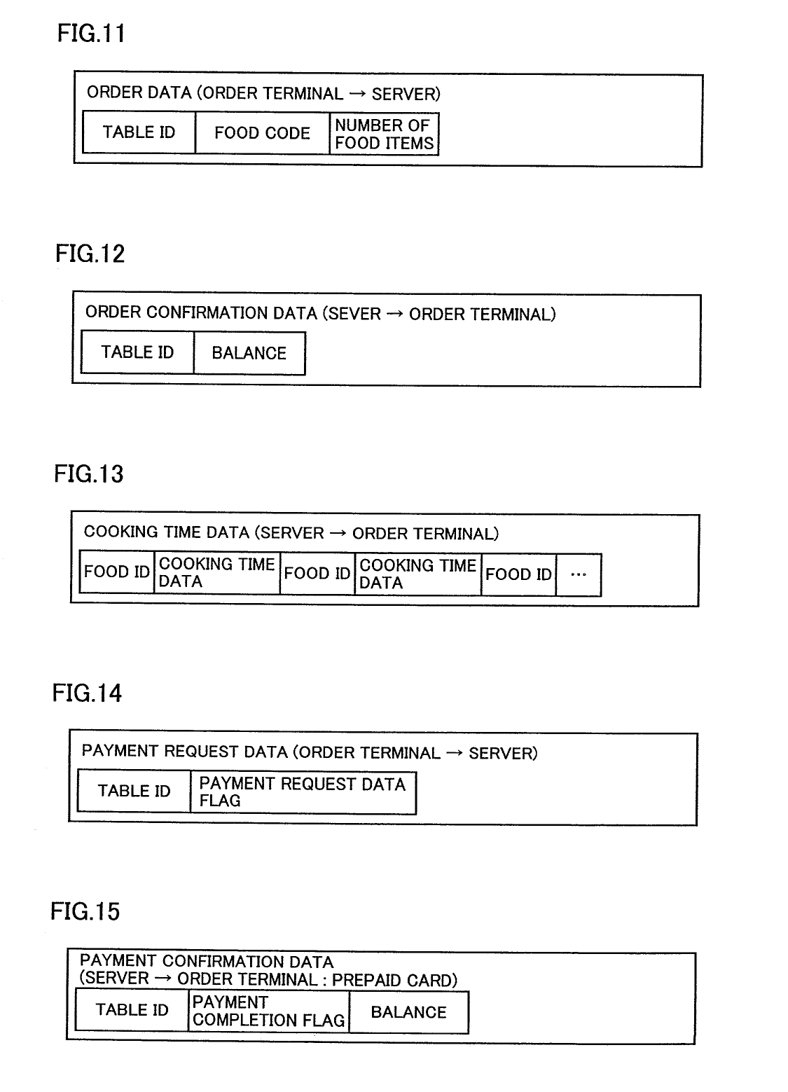

Referring to FIG. 11, order data transmitted from the order terminal 100 to the server 400 includes: a table ID; a food code indicating food items for which a guest places an order and the number of the food items. The food code is a combination of numbers set so as to uniquely specify the food item served to a guest.

Referring to FIG. 12, order confirmation data is transmitted from the server 400 to the order terminal 100 that has transmitted the order data shown in FIG. 11 to the server 400. The order confirmation data includes: a table ID; and a balance. Note that the balance is updated each time the server 400 receives one order data. The order confirmation data is transmitted to the order terminal 100 each time the balance is updated.

Referring to FIG. 13, a cooking time is transmitted from the server 400 to all of the other order terminals 100 at prescribed intervals. The cooking time data is data prepared by repetition of a combination of a food ID and cooking time data. Cooking time data expresses an average cooking time for cooking a food item corresponding to the food ID.

Referring to FIG. 14, payment request data is transmitted from the order terminal 100 to the server 400 in response to the fact that the payment request button is inputted from the input key 106 of the order terminal 100. The payment request data includes: a table ID; and a payment request data flag. The server 400 identifies a payment request data transmitted to the server 400.

Referring to FIG. 15, payment confirmation data is transmitted from the server 400 to the order terminal 100 if a card inserted in the card read/write section 114 of the order terminal 100 is the prepaid card. The payment confirmation data shown in FIG. 15 is transmitted to the order terminal 100 (payment with a prepaid card) that has transmitted the payment request data shown in FIG. 14 to the server 400. The payment confirmation data includes: a table ID; a payment completion flag; and a balance.

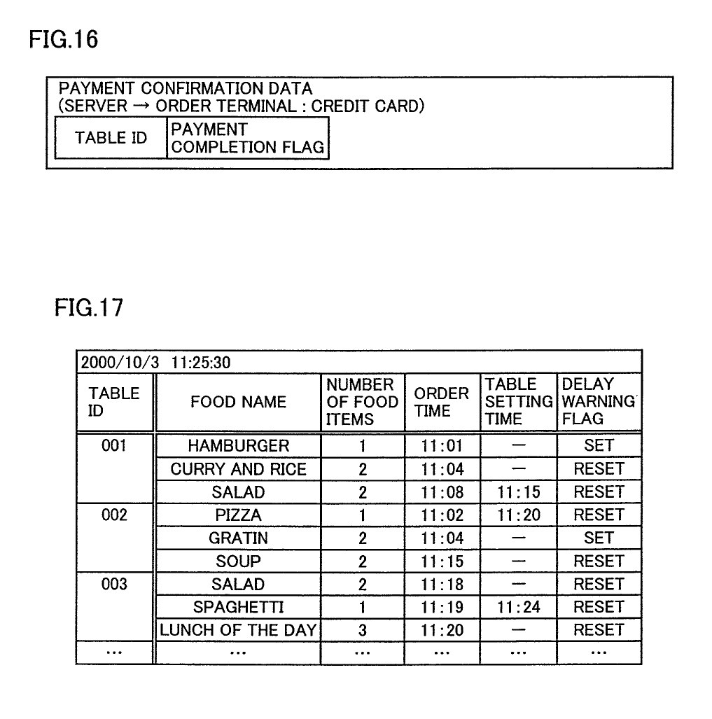

Referring to FIG. 16, payment confirmation data is transmitted from the server 400 to the order terminal 100 if a card inserted in the card read/write section 114 of the order terminal 100 is a credit card. The payment confirmation data shown in FIG. 16 is transmitted to the order terminal 100 (payment with a credit card) that has transmitted the payment request data shown in FIG. 14 to the server 400. The payment confirmation data includes: a table ID; and a payment completion flag.

Referring to FIG. 17, description will be given of order data classified by table stored on the fixed disk 424 of the server 400. The order data classified by table, as shown in FIG. 17, includes: for each table ID, names of ordered food items, a number of food items; an order time point expressing a time at which the server 400 receives the order data from the order terminal 100; a table setting time point expressing a time point at which the server 400 receives a table setting information from the serving terminal 200; and a delay warning flag that will be set when a prescribed time elapses from an order time point. For example, at a table with a table ID of [001], a hamburger was ordered at 11:01. A current time point is 11:25. No table setting time point has been inputted, even though 24 minutes have elapsed after ordering, which exceeds a time limit (15 minutes) till which a delay is tolerated in serving a hamburger; therefore a delay warning flag is set.

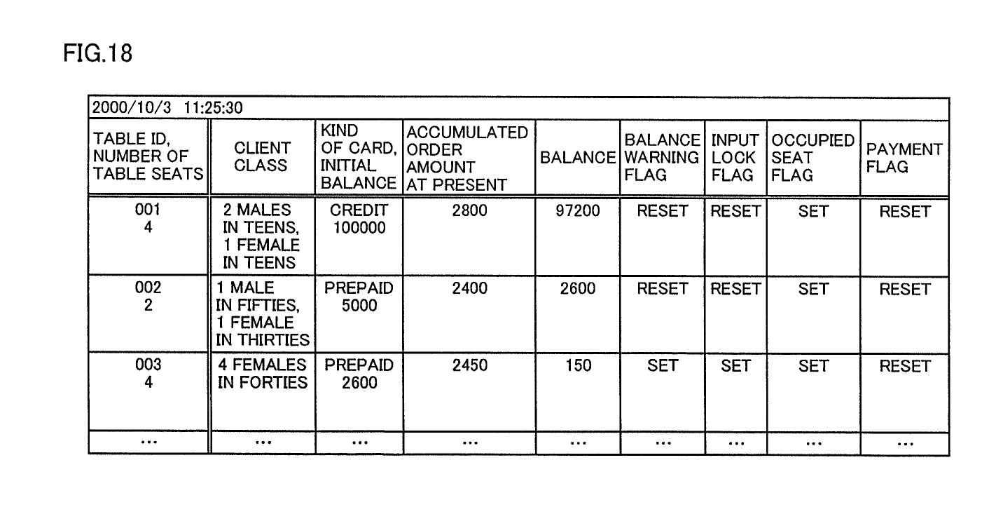

Referring to FIG. 18, table status data stored on the fixed disk 424 of the server 400 includes: for each table ID, client class data; a kind of a card; an initial balance; an accumulated order amount at the present time, a balance, a balance warning flag; an input lock flag; an occupied flag; and,,a payment flag.

The client data is inputted by an employee having set food on a table visually confirming sexes and age brackets of guests at a table of interest from the input key 206 of the serving terminal 200. A kind of a card is discriminated with the card flags shown in FIGS. 8 and 9. In a case of a prepaid card, an initial balance is set on the basis of the balance shown in FIG. 8. In a case of a credit card, an initial balance is set on the basis of a balance received from a credit company (a credit limit up to which payment can be effected with the credit card). A balance is an amount of money obtained by subtracting a cumulative sum of order prices having been ordered from the initial balance.

A balance warning flag is set when a balance is equal to or less than a predetermined amount. An input lock flag is set when a balance is further reduced. An occupied seat flag is set when the balance data shown in FIG. 8 or the authentication request data shown in FIG. 9 is received. A payment flag is set when the payment request data shown in FIG. 14 is received.

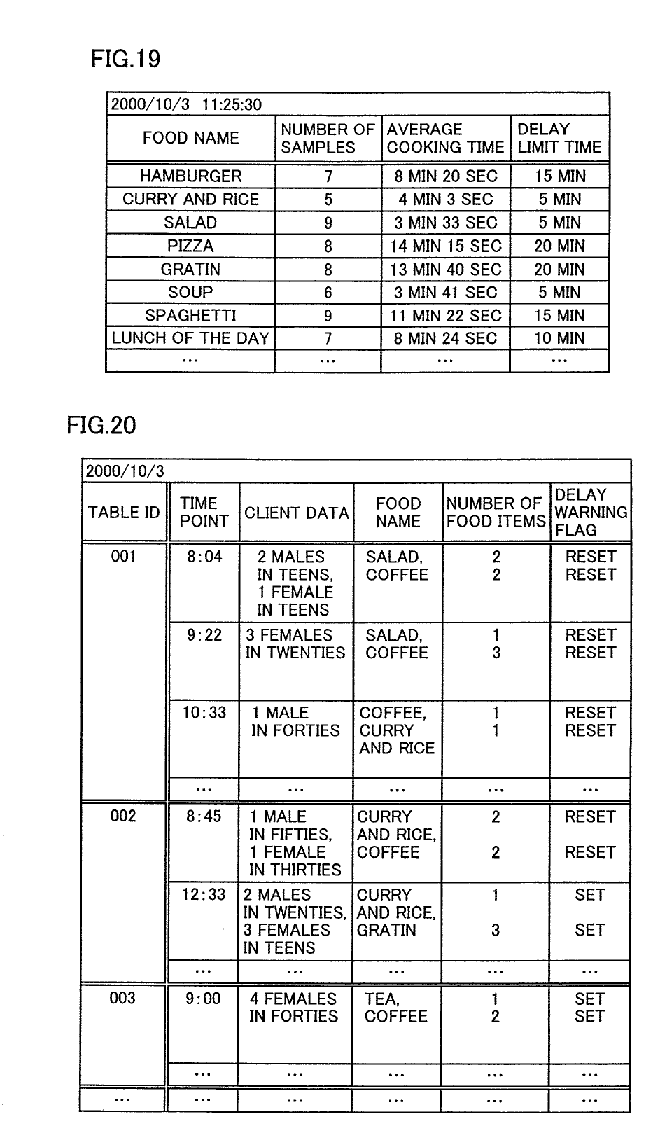

Referring to FIG. 19, delay limit data includes: for each food item, an average cooking time; the number of samples used for calculating the average cooking time; and a limit time up to which a delay is tolerated. The average cooking time is calculated as an average of differences each obtained by subtracting an order time point from a table setting time point for each of food items at a table as shown in FIG. 17. A time limit up to which a delay is tolerated is set for each food item. For example, the time limit for a tolerated delay is set as a 150% of an average cooking time which is updated when a new average time becomes available.

Referring to FIG. 20, totalized order data stored on the fixed disk 424 of the server 400 includes: for each table ID, an order time point of a first food item, client data, ordered food items; the number of orders; and a delay warning flag. For example, in regard to a table with a table ID of [001], it is shown that two males in their teens and one female in her teens placed an order for two salads at 8:04. Furthermore, the guests at the table placed an order for two cups of coffee. The delay warning flag is reset for the salads and the coffee. That is, it is shown that the salads and the coffee were served within a tolerable delay limit time as shown in FIG. 19. In regard to this table, three females in their twenties further placed an order for food items at 9:22 and one male in his forties still further placed an order for food items at 10:33.

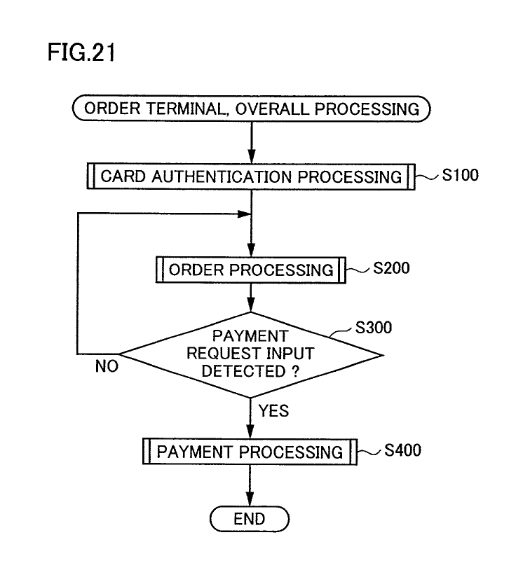

Referring to FIG. 21, a program executed in the order terminal 100 has the following control structure for the overall processing:

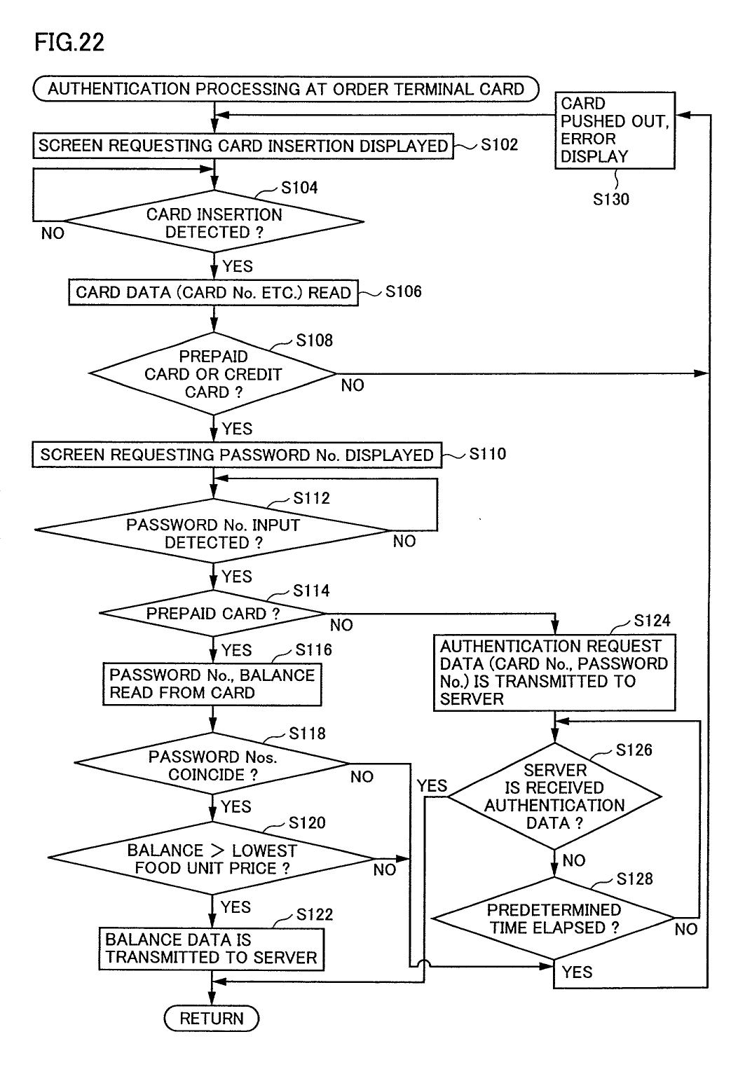

First of all, in step (hereinafter referred to as S for short) 100, the CPU 102 performs card authentication processing. Detailed description will be given of the card authentication processing later with reference to FIG. 22.

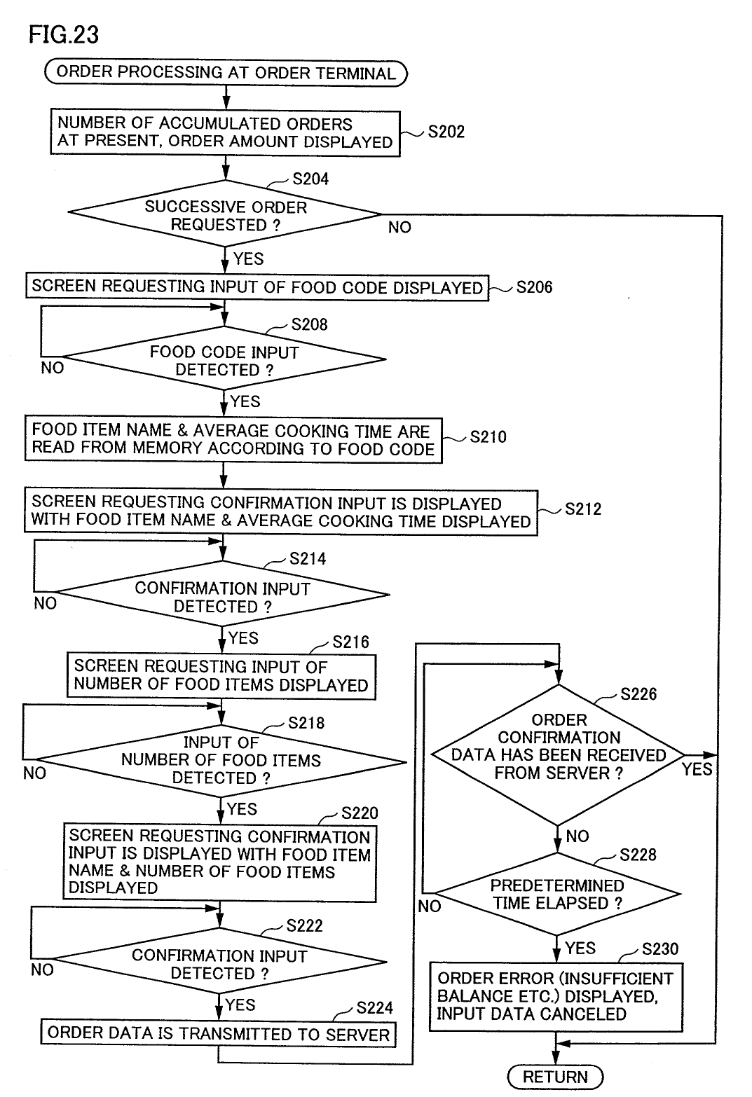

In S200, the CPU 102 performs order processing. Details of the order processing will be described later with reference to FIG. 23.

In S300, the CPU 102 determines whether or not an input requesting payment has been detected. This determination is effected according to whether or not a button requesting payment is pushed down from the input key 106. If the input requesting payment has been detected (in step S300, determination is YES), the program proceeds to S400. If no input requesting payment has been detected, (in S300, determination is NO), the program returns to S200, where order processing is performed.

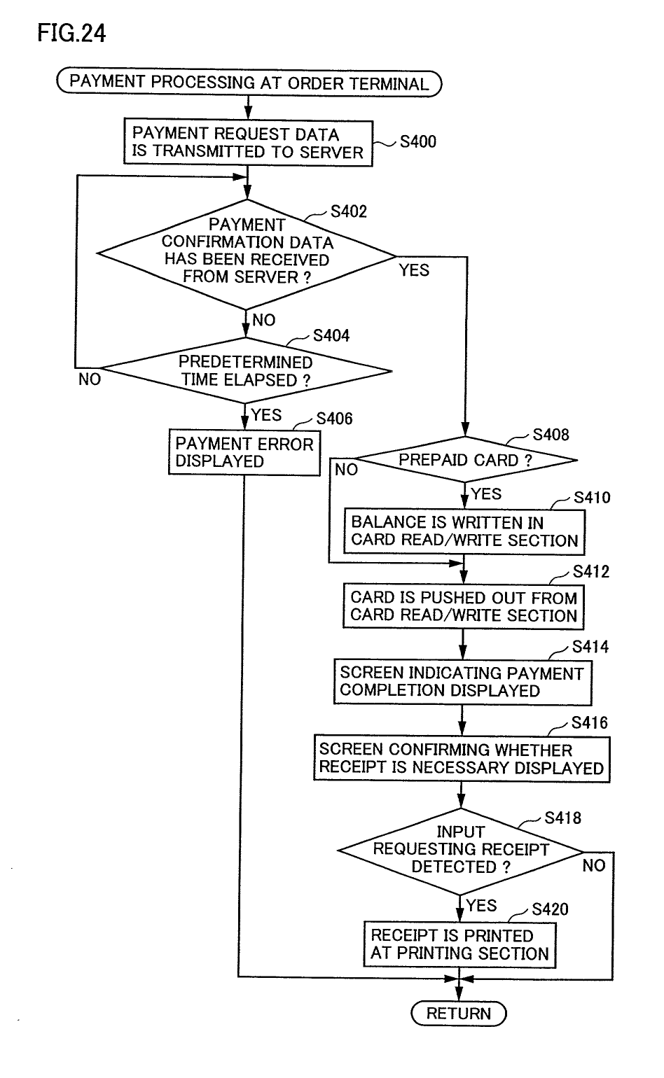

In S400, the CPU 102 performs payment processing. Details of the payment processing will be described later with reference to FIG. 24.

Referring to FIG. 22, the program executed in the order terminal 100 has the following control structure for card authentication processing:

In S102, the CPU 102 displays a screen image requesting insertion of a card on the display section 110. In S104, the CPU 102 determines on whether or not a card has been inserted into the card read/write section 114. If a card has been inserted (in S104, determination is YES), the program proceeds to S106. On the other hand, if no card has been inserted (in S104, determination is NO), the program returns to S104, where insertion of the card is awaited.

In S106, the CPU 102 forces the card read/write section 114 to read data on an inserted card (a card number and others). In S108, the CPU 102 determines whether or not the inserted card is a prepaid card or a credit card. This determination is effected on the basis of data read out from the card in S106. If the inserted card is a prepaid card or a credit card (in S108, determination is YES), the program proceeds to S110. If the inserted card is neither a prepaid card nor a credit card, (in S108, determination is NO), the program proceeds to S130.

In S110, the CPU 102 displays a screen image requesting input of a password number to the display section 110. In S112, the CPU 102 determines whether or not a password number has been inputted from the input key 106. If the password number has been inputted (in S112, determination is YES), the program proceeds to S114. If no password has been inputted (in S112, determination is NO), the program returns to S112, where input of the password is awaited.

In S114, the CPU 102 determines whether or not a card inserted into the card read/write section 114 is a prepaid card. This determination is effected on the basis of data readout from the card in S106. If the inserted card is a prepaid card (in S114, determination is YES), the program proceeds to S116. If the inserted card is not a prepaid card (in S114, determination is NO), the program proceeds to S124.

In S116, the CPU 102 forces the card read/write section 114 to read a password number and a balance from a prepaid card. Note that the processing in S116 can also be performed in S106.

In S118, the CPU 102 determines whether or not a password number inputted in S112 coincides with the password number readout in S116. If the password numbers coincide with each other (in S118, determination is YES), the program proceeds to S120. If the password numbers do not coincide with each other (in S118, determination is NO), the program proceeds to S130.

In S120, the CPU 102 determines whether or not the balance read out in S116 is larger than the lowest of food item unit price (hereinafter also referred to the lowest price) at the restaurant. If the balance is larger than the lowest price (in S120, determination is YES), the program proceeds to S122. If the balance is equal to or smaller than the lowest price (in S120, determination is NO), the program proceeds to S130.

In S122, the CPU 102 transmits the balance data shown in FIG. 8 to the server 400. After the processing in S122, the card authentication processing is finished.

In S124, the CPU 102 transmits the authentication request data (a card number and a password number) shown in FIG. 9 to the server 400 when an inserted card is a credit card.

In S126, the CPU 102 determines whether or not the authentication data shown in FIG. 10 has been received. If the authentication data has been received from the server 400 (in S126, determination is YES), the card authentication processing is finished.

In S128, the CPU 102 determines whether or not a predetermined time has elapsed after the CPU 102 transmitted the authentication request data to the server 400. If the predetermined time has elapsed (in S128, determination is YES), the program proceeds to S130. On the other hand, if the predetermined time has not elapsed (in S128, determination is NO), the program returns to S126, where receipt of the authentication data from the server 400 is awaited till the predetermined time elapses.

In S130, if an inserted card is neither a prepaid card nor a credit card (in S108, determination is NO); if a password number read out from a prepaid card does not coincide with a password number inputted (in S118, determination is NO); if a balance on a prepaid card is equal to or smaller than the lowest price (in S120, determination is NO); or if the inserted card is a credit card and the authentication data is not received even when the predetermined time has elapsed after the authentication data was transmitted to the server 400 (in S128, determination is YES), the CPU 102 pushes out the card from the card read/write section 114 and displays error generation on the display section 110.

Referring to FIG. 23, the program executed in the order terminal 100 has the following control structure for order processing:

In S202, the CPU 102 displays the number of accumulated orders at the present and an accumulated amount of money on the display section 110. The number of accumulated orders and the accumulated amount of money are stored in the memory 104 of the order terminal 100. In the processing of S202, the CPU 102 may display a balance of a prepaid card or a balance based on a credit limit up to which payment can be effected with the credit card on the display section 101. The balance is included in the order confirmation data shown in FIG. 12 transmitted from the server 400.

In S204, the CPU 102 determines whether or not a request for a successive order has been inputted. This determination is effected according to whether or not a predetermined key is inputted from the input keys 106. If the successive order request has been inputted (in S204, determination is YES), the program proceeds to S206. If no successive order request has been inputted (in S204, determination is NO), the order processing is finished.

In S206, the CPU 102 displays a screen image requesting input of the food code on the display section 110. In S208, the CPU 102 determines whether or not the food code has been inputted from the input key 106. If the food code has been inputted (in S208, determination is YES), the program proceeds to S210. If no food code has been inputted (in S208, determination is NO), the program returns to S208, where input of the food code is awaited.

In S210, the CPU 102 reads a name of an ordered food item and an average cooking time according to the food code detected in S208.

In S212, the CPU 102 displays the name of a food item read out in S210 and the average cooking time on the display section 110 and further a screen image requesting input of confirmation thereon. In S214, the CPU 102 determines whether or not the confirmation is inputted. This confirmation is performed according to whether or not a prescribed key is inputted from the input key 106. If the confirmation has been inputted (in S214, determination is YES), the program proceeds to S216. If the confirmation has not been inputted (in S214, determination is NO), the program returns to S214, where input of the confirmation is awaited.

In S216, the CPU 102 displays a screen image requesting input of the number of food items on the display section 110. In S218, the CPU 102 determines whether or not the number of food items has been inputted. If the number is inputted (in S218, determination is YES), the program proceeds to S220. If the number has not been inputted (in S218, determination is NO), the program returns to S218, where input of the number is awaited.

In S220, the CPU 102 displays names corresponding to the food codes inputted and the number of the food codes on the display section 110 and further a screen image requesting input of confirmation thereon.

In S222, the CPU 102 determines whether or not the input of confirmation has been detected. This determination is performed according to whether or not a prescribed input from the input key 106 is performed. If the confirmation has been inputted (in S222, determination is YES), the program proceeds to S224. If no confirmation has been inputted (in S222, determination is NO), the program returns to S111, where the input of confirmation is awaited.

In S224, the CPU 102 transmits the order data shown in FIG. 11 to the server 400.

In S226, the CPU 102 determines whether or not the order confirmation data shown in FIG. 12 has been received from the server 400. If the order confirmation data has been received from the server 400 (in, S226, determination is YES), this order processing is finished. If the order confirmation has not been received from the server 400 (in S226, determination is NO), the program proceeds to S228.

In S228, the CPU 102 determines whether or not a predetermined time has elapsed after order data is transmitted to the server 400. If the predetermined time has elapsed (in S228, determination is YES), the program proceeds to S230. If the predetermined time has not elapsed (in S228, determination is NO), the program returns to S226, where reception of the order confirmation data from the server 400 is awaited till the predetermined time elapses.

In S230, the CPU 102 displays order error (an insufficient balance) on the display section 110 and cancels input data.

Referring to FIG. 24, the program executed in the order terminal 100 has the following control structure for payment processing:

In S400, the CPU 102 transmits the payment request data shown in FIG. 14 to the server 400. In S402, the CPU 102 determines whether the payment confirmation data shown in FIG. 15 or 16 has been received from the server 400. If the payment confirmation data has been received from the server 400 (in S402, determination is YES), the program proceeds to S408. If the payment confirmation data has not been received from the server 400 (in S402, determination is NO), the program proceeds to S404.

In S404, the CPU 102 determines whether or not a predetermined time has elapsed after the payment request data is received by the server 400. If the predetermined time has elapsed (in S404, determination is YES), the program proceeds to S406. If the predetermined time has not elapsed (in S404, determination is NO), the program returns to S402, where reception of the payment confirmation data from the server 400 is awaited till the predetermined time elapses.

In S406, the CPU 102 displays payment error generation on the display section 110. After the processing in S406, this payment processing is finished. In this case, since a prepaid card or a credit card is not pushed out from the card read/write section 114, the payment error generation is noticed to an employee of the restaurant and the employee performs charge processing in cash or the like.

In S408, the CPU 102 determines whether or not a card inserted in the card read/write section 114 is a prepaid card. If the card is a prepaid card, (in S408, determination is YES), the program proceeds to S410. If the card inserted in the card read/write section 114 is not a prepaid card, (in S408, determination is NO), the program proceeds to S412.

In S410, the CPU 102 writes a balance included in the payment confirmation data received from the server 400 on the prepaid card with the card read/write section 114.

In S412, the CPU 102 pushes out the card from the card read/write section 114. In S414, the CPU 102 displays a screen image indicating completion of the payment on the display section 110.

In S416, the CPU 102 displays a screen image confirming whether or not a receipt printed by the printing section 112 is necessary. In S418, the CPU 102 determines whether or not a request for the receipt has been inputted. This determination is performed according to whether or not a prescribed key is inputted from the input key 106. If the request for a receipt has been inputted (in S418, determination is YES), the program proceeds to S420. If the request has not been inputted (in S418, determination is NO), this payment processing is finished.

In S420, the CPU 102 causes the printing section 112 to print the receipt. After the processing in S420, this payment processing is finished.

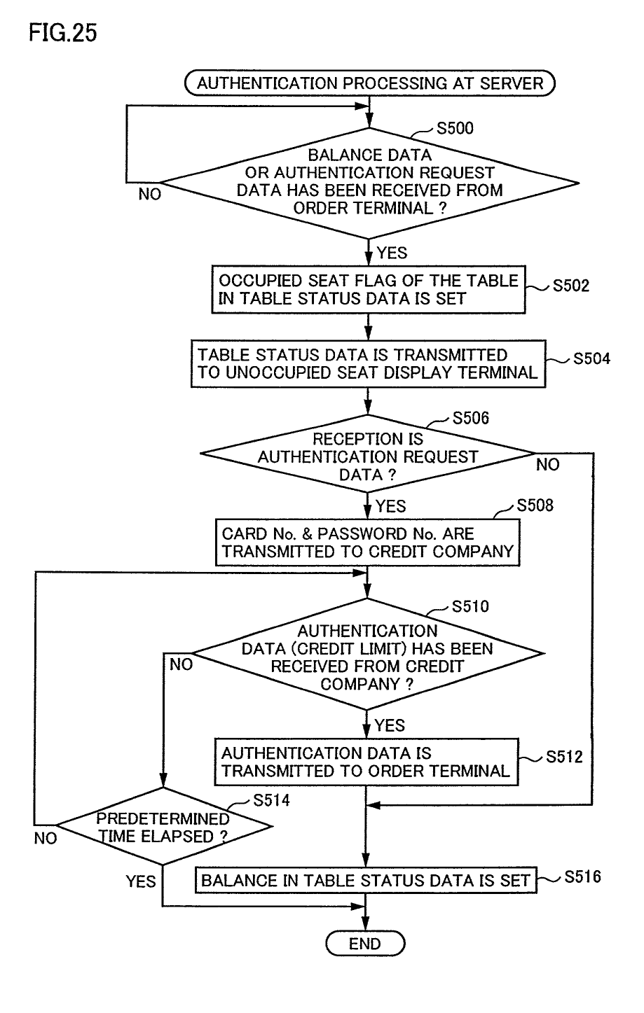

Referring to FIG. 25, a program executed in the server 400 has the following control structure for authentication processing:

In S500, the CPU 420 determines whether or not the balance data shown in FIG. 8 or the authentication request data shown in FIG. 9 has been received from an order terminal 100. If the balance data or the authentication request data has been received from the order terminal 100 (in S500, determination is YES), the program proceeds to S502. If the balance data or the authentication request data has not been received from the order terminal 100 (in S500, determination is NO), the program returns to S500, where reception of the balance data or the authentication request data from the order terminal 100 is awaited.

In $502, the CPU 402 sets an occupied seat flag of the table of the authentication request data in the table status data shown in FIG. 18. This processing is performed by setting the occupied seat flag of the table on the basis of a table ID included in the data shown in FIG. 8 or 9. In S504, the CPU 420 transmits the table status data shown in FIG. 18 to the unoccupied seat display terminal 500.

In S506, the CPU 420 determines whether or not the data received in S500 is authentication data. This determination is performed on the basis of the card flag shown in FIG. 8 or 9. If the received data is the authentication request data (in S506, determination is YES), the program proceeds to S508. If the received data is not the authentication request data (in S506, determination is NO), the program proceeds to S516.

In S508, the CPU 420 transmits a password number and a card number included in the received authentication request data to a server of a credit company issuing the card. The server 400 can uniquely specify the credit company on the basis of the card number. The server 400 can realize on-line authentication with each credit company.

In S510, the CPU 420 determines whether or not authentication completion data (including data expressing a credit limit up to which payment can be effected with the credit card) has been received from the server of the credit company. If the authentication completion data has been received from the server of the credit company (in S510, determination is YES), the program proceeds to S512. If the authentication completion data has not been received from the server of the credit company (in S510, determination is NO), the program proceeds to S514.

In S512, the CPU 420 transmits the authentication data shown in FIG. 10 to the order terminal 100.

In S514, the CPU 420 determines whether or not a predetermined time has elapsed after the card number and the password number are transmitted to the server of the credit company. If the predetermined time has elapsed (in S514, determination is YES), this authentication processing is finished. If the predetermined time has not elapsed (in S514, determination is NO), the program returns to S510, where reception of the authentication completion data from the server of the credit company is awaited till the predetermined time elapses.

In S516, the CPU 420 sets the balance of the table status data shown in FIG. 18. When data received from the order terminal 100 is balance data, the balance included in the balance data shown in FIG. 8 is set. When the data received from the order terminal 100 is an authentication request data, the balance is set to a credit limit included in an authentication completion data received from the credit company and up to which payment can be effected with the credit card. The credit limit that the server 400 receives from the credit company is a limit up to which the company allows a user of the credit card to perform payment with the credit card. The credit limit is an amount up to which payment can be effected with the credit card for one day or for one time transaction. After the processing in S516, this authentication processing is finished.

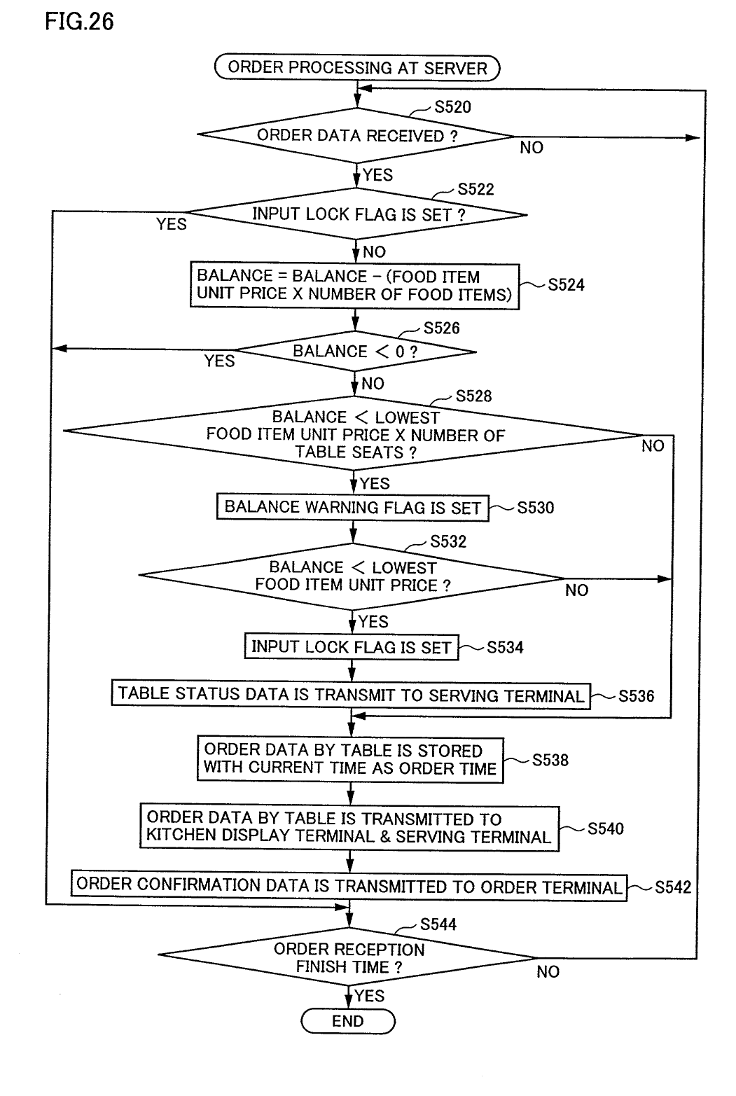

Referring to FIG. 26, the program executed in the server 400 has the following control structure for order processing:

In S520, the CPU 420 determines whether or not the order data shown in FIG. 11 has been received from the order terminal 100. If the order data has been received (in S520, determination is YES), the program proceeds to S522. If the order data has not been received (in S520, determination is NO), the program returns to S520, where reception of the order data from the order terminal 100 is awaited.

In S522, the CPU 420 determines whether or not an input lock flag is set on the basis of the table status data shown in FIG. 18. If the input lock flag is set (in S522, determination is YES), the program proceeds to S544. If the input lock flag is reset (in S522, determination is NO), the program proceeds to S524.

In S524, the CPU 420 performs an operation of a new balance={a current balance−(a food unit price x the number of food items)}. In S526, the CPU 420 determines whether or not the new balance in S524 is negative. If the new balance is negative (in S526, determination is YES), the program proceeds to S544. If not (in S526, determination is NO), the program proceeds to S528.

In S528, the CPU 420 determines whether or not the new balance calculated in S524 is less than a value (of the lowest food unit price x the number of seats at a table of interest, hereinafter referred to as the latter value), wherein the lowest food unit price otherwise includes an amount obtained by adding taxes such as a consumption tax to the lowest food unit price and the number of seats at a table is the number of seats. If the new balance is less than the latter value (in S528, determination is YES), the program proceeds to S530. If the new balance is equal to or more than the latter value (in S528, determination is NO), the program proceeds to S538. Note that the number of seats at a table is stored in advance for each table ID of the table status data shown in FIG. 18.

In S530, the CPU 420 sets the balance warning flag shown in FIG. ? 18. In S532, the CPU 420 determines whether or not the new balance calculated in S524 is less than the lowest food unit price. If the new balance is less than the lowest food unit price (in S532, determination is YES), the program proceeds to S534. If the new balance is equal to or more than the lowest food unit price (in S532, determination is NO), the program proceeds to S538.

In S534, the CPU 420 sets the input lock flag of the table status data shown in FIG. 18.

By performing the processing from S528 to S534, when a newly calculated balance is less than the lowest food unit price, the input lock flag is set. When the newly calculated balance is less than a value of the lowest food unit price x the number of seats at a table of interest, the balance warning flag is set.

In S536, the CPU 420 transmits the table status data shown in FIG. 18 to the serving terminal 200.

In S538, the CPU 420 stores a current time point when ordered in order data classified by table shown in FIG. 17 as an order time point.

In S540, the CPU 420 transmits order data classified by table shown in FIG. 17 to the kitchen display terminal 300 and the serving terminal 200.

In S542, the CPU 420 transmits the order confirmation data shown in FIG. 12 to the order terminal 100.

In S544, the CPU 420 determines whether or not a current time point has reached an order reception finish time point. If the current time has reached the order reception finish time point (in S544, determination is YES), this order processing is finished. If not (in S544, determination is NO), the program returns to S520, where the order data from the order terminal 100 is awaited.

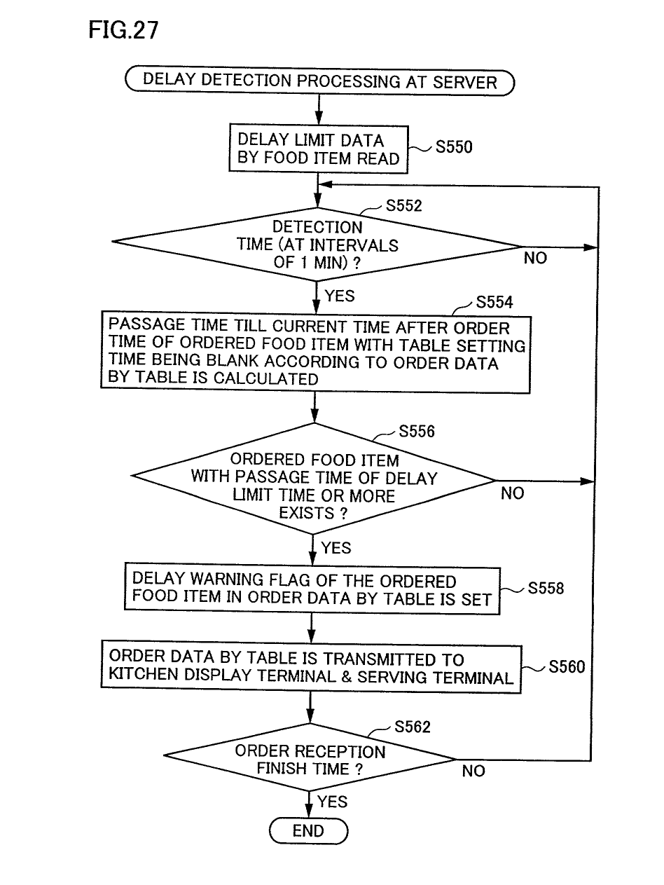

Referring to FIG. 27, the program executed in the server 400 has the following structure for delay detection processing:

In S550, the CPU 420 reads out delay limit data for each food item stored on the fixed disk 424. In this processing, read out is a limit time shown in FIG. 19 and up to which a delay of delay limit data is tolerated.

In S552, the CPU 420 determines whether or not a current time point is a time point at which a delay is to be detected. Time points at which a delay is to be detected are set, for example, at intervals of one minute. If the current time point is the time point at which a delay is to be detected (in S552, determination is YES), the program proceeds to S554. If not (in S552, determination is NO), the program returns to S552, where arrival at the time point of detection is awaited.

In S554, the CPU 420 calculates a passage time from an order time point to a current time point for a food item whose table setting time point has not been inputted yet on the basis of the order data at a table of interest shown in FIG. 17. In S556, the CPU 420 determines whether or not there is still left a food item for which the passage time calculated in S554 is equal to or more than a limit time up to which a delay is tolerated. If there exists a food item for which the passage time is equal to or more than the limit time up to which a delay is tolerated (in S556, determination is YES), the program proceeds to S558. If not (in S556, determination is NO), the processing returns to S552.

In S558, the CPU 420 sets a delay warning flag to the excessively delayed food item in the order data classified by table shown in FIG. 17. In S560, the CPU 420 transmits the order data classified by table shown in FIG. 17 to the kitchen display terminal 300 and the serving terminal 200.

In S562, the CPU 420 determines whether or not a current time point has reached an order reception finish time point. If the current time point has reached the order reception finish time point (in S562, determination is YES), this delay detection processing is finished. If not (in S562, determination is NO), the program returns to S552, where a passage time is calculated, and there is extracted is a food item for which the passage time is equal to or more than the limit time up to which a delay is tolerated at each and every detection time which successively comes.

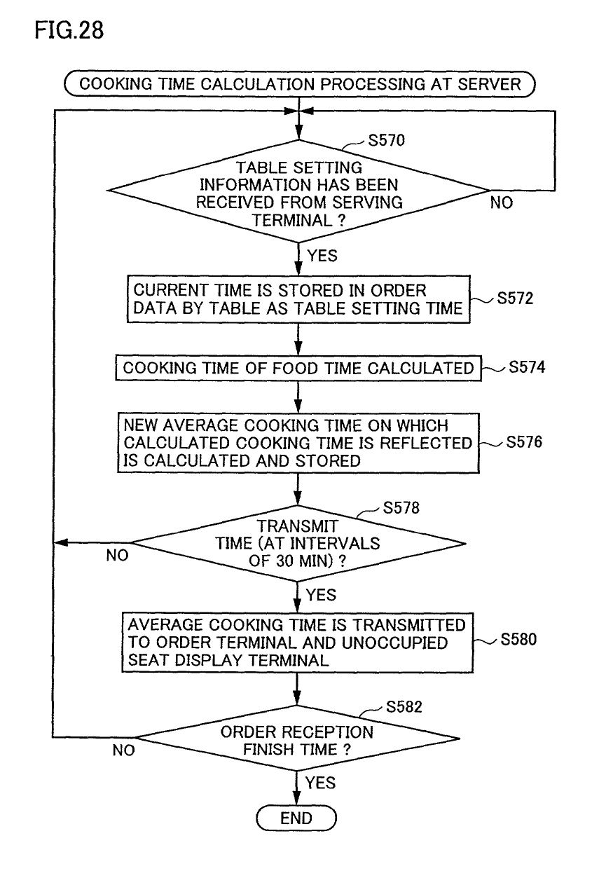

In FIG. 28, the program executed in the server 400 has the following control structure for processing for calculating a cooking time:

In S570, the CPU 420 determines whether or not table setting information has been received from the serving terminal 200. The table setting information in this processing corresponds to information inputted by an employee in charge of table setting in a restaurant. An employee in charge of setting food on a table inputs table setting information for a cooked food item from the input key 206 of the serving terminal 200 prior to table setting of the cooked food item. If the table setting information has been received from the serving terminal 200 (in S570, determination is YES), the program proceeds to S572. If not (in S570, determination is NO), the program returns to S570, where the table setting information from the serving terminal 200 is awaited.

In S572, the CPU 420 stores a current time point in the order data classified by table shown in FIG. 17 as a table setting time point.

In S574, the CPU 420 calculates a cooking time for a food item of interest from the order time point and the table setting time shown in FIG. 14.

In S576, the CPU 420 calculates and stores a new average cooking time of the food item on which the cooking time calculated in S574 is reflected.

In S578, the CPU 420 determines whether or not a current time point is a transmit time for an average cooking time. This transmit time point is set so as to be repeated at intervals of 30 minutes. If the current time point is a transmit time (in S578, determination is YES) the program proceeds to S580. If not (in S578, determination is NO) the program returns to S570.

In S580, the CPU 420 transmits the average cooking time shown in FIG. 19 to the order terminal 100 and the unoccupied seat display terminal 500. At this time, the cooking time data shown in FIG. 13 is transmitted.

In S582, the CPU 420 determines whether or not a current time has reached an order reception finish time point. If the current time has reached the order reception finish time point (in S582, determination is YES), this cooking time calculation processing is finished. If not (in S582, determination is NO), the program returns to S570 till a current time reaches the order reception finish time point.

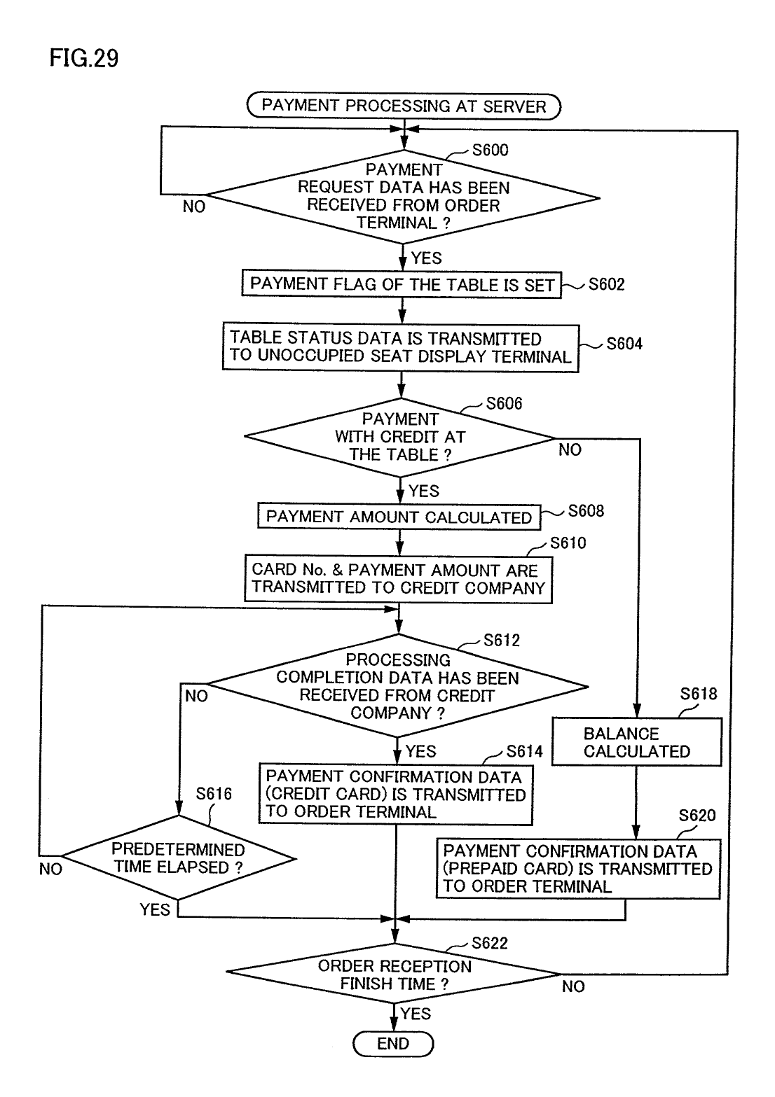

Referring to FIG. 29, the program executed in the server 400 has the following control structure for payment processing:

In S600, the CPU 420 determines whether or not the payment request data shown in FIG. 14 has been received from an order terminal 100. If the payment request data has been received from the order terminal 100 (in S600, determination is YES), the program proceeds to S602. If not (in S600, determination is NO), the program returns to S600, where awaited is reception of the payment request data from the order terminal 100.

In S602, the CPU 420 sets the payment flag of the table status data shown in FIG. 18 on the basis of the table ID included in the payment request data shown in FIG. 14.

In S604, the CPU 420 transmits the table status data shown in FIG. 18 to the unoccupied seat display terminal 500.

In S606, the CPU 420 determines whether or not payment with a credit card is performed at the table of the order terminal on the basis of data expressing a kind of a card included in the table status data shown in FIG. 18. If the payment with a credit card is performed at the table of the order terminal (in S606, determination is YES), the program proceeds to S608. If not (in S606, determination is NO), the program proceeds to S618.

In S608, the CPU 420 calculates a payment amount of money. In S610, the CPU 420 transmits a card number and the payment amount of money to a server of a credit company. In S612, the CPU 420 determines whether or not processing completion data has been received from the server of the credit company. If the processing completion data has been received from the server of the credit company (in S612, determination is YES), the program proceeds to S614. If not (in S612, determination is NO), the program proceeds to S616.

In S614, the CPU 420 transmits the payment confirmation data (for a credit card) shown in FIG. 16 to the order terminal 100 from which payment request data has been transmitted.

In S616, the CPU 420 determines whether or not a predetermined time has elapsed after the card number and the payment amount of money was transmitted to the server of the credit company. If the predetermined time has been elapsed (in S313, determination is YES), the program proceeds to S622. If not (in S616, determination is NO), the program returns to S612, where reception of the processing completion data from the server of the credit company is awaited till the predetermined time elapses.

When the predetermined time has elapsed after the card number and the payment amount of money were transmitted to the server of the credit company, the payment confirmation data shown in FIG. 16 is not transmitted to the order terminal 100 from which payment request data has been transmitted. In this case, in the order terminal 100 from which the payment request data has been transmitted, it is detected that the predetermined time has elapsed after transmission of the payment request data and error processing is performed.

In S618, the CPU 420 calculates a balance of a prepaid card. In S620, the CPU 420 transmits the payment confirmation data (for a prepaid card) shown in FIG. 15 to the order terminal 100 from which payment request data has been transmitted.

In S622, the CPU 420 determines whether or not a current time point has reached an order reception finish time point after the processing in S614, S616 and S620. If the current time point has reached the order reception finish time point (in S622, determination is YES), this payment processing is finished. If the current time point has not reached the order reception finish time point (in S622, determination is NO), the program returns to S600 till a current time point reaches the order reception finish time point.

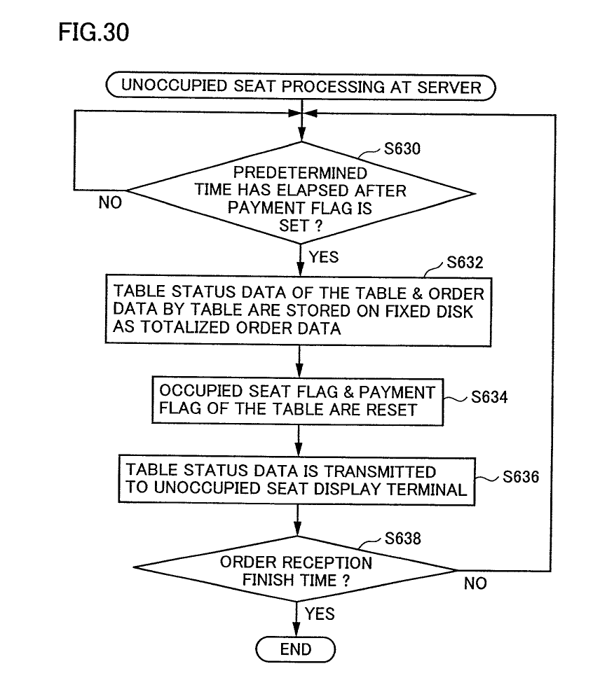

Referring to FIG. 30, the program executed in the server 400 has the following structure for unoccupied seat processing:

In S630, the CPU 420 determines whether or not a predetermined time has elapsed after setting a payment flag of the table status data shown in FIG. 18. Note that the table status data stores time points when an occupied seat flag and a payment flag were set and reset.

If the predetermined time has elapsed after setting the payment flag (in S630, determination is YES), the program proceeds to S632. If the predetermined time has not elapsed after setting the payment flag (in S630, determination is NO), the program returns to S630 to await there till the predetermined time elapses after setting the payment flag. This predetermined time means at least a time obtained by adding a time till employees clean up a table after guests left the table to a time till payment processing is finished after a payment request button was pushed.

In S632, the CPU 420 stores table status data of a table for which a predetermined time has elapsed after the payment flag was set and order data classified by table on the fixed disk 424 as the totalized order data shown in FIG. 20.

In S634, the CPU 420 resets an occupied seat flag and a payment flag of the table status data shown in FIG. 18, at a table for which a predetermined time has elapsed after the payment flag was set.

In S636, the CPU 420 transmits the table data status shown in FIG. 18 to the unoccupied seat display terminal 500.

In S638, the CPU 420 determines whether or not a current time has reached the order reception finish time point. If the current time point has reached the order reception finish time point (in S638, determination is YES), this unoccupied seat processing is finished. If not (in S638, determination is NO), the program returns to S630 till the current time point reaches the order reception finish time point.

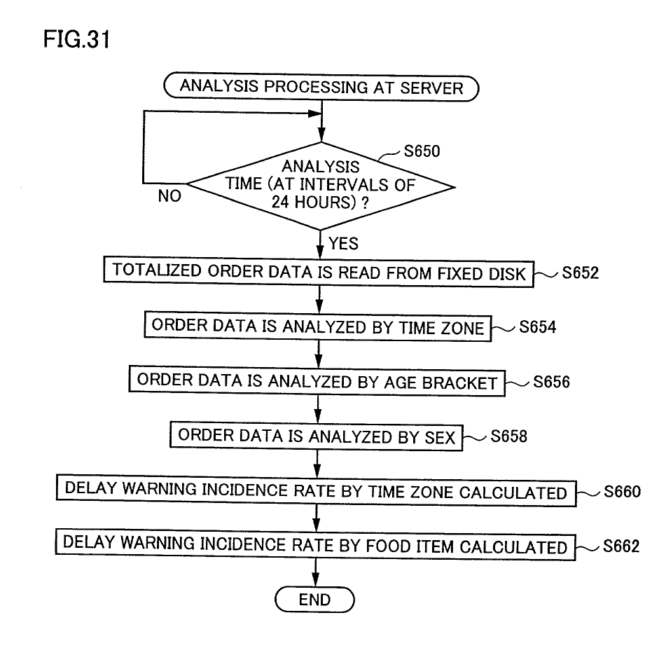

Referring to FIG. 31, the program executed in the server 400 has the following control structure for analysis processing:

In S650, the CPU 420 determines whether or not a current time point has reached a time point at which the analysis processing is to be performed. Time points at which the analysis processing are performed are set, for example, at intervals of 24 hours. If the current time point is the time point at which the analysis processing is performed (in S650, determination is YES), the program proceeds to S652. If not (in S650, determination is NO), the program returns to S650, where the time point is awaited at which the analysis processing is to be performed.

In S652, the CPU 420 reads out totalized order data from the fixed disk 424.

In S654, the CPU 420 analyzes order data classified by time zone on the basis of the totalized order data read out. In S656, the CPU 420 analyzes order data classified by age bracket on the basis of the totalized order data read out. In S658, the CPU 420 analyzes order data classified by sex on the basis of the totalized order data read out.

In S660, the CPU 420 calculates incidence rates of delay warnings classified by time zone on the basis of the totalized order data read out. In S662, the CPU 420 calculates incidence rates of delay warnings classified by food item on the basis of the totalized order data read out.

The general manager of the restaurant can calculate the number of employees in each time zone and determine an optimal number of employees so as not to increase incidence rates of delay warnings on the basis of the results of the analysis processing in the server 400.

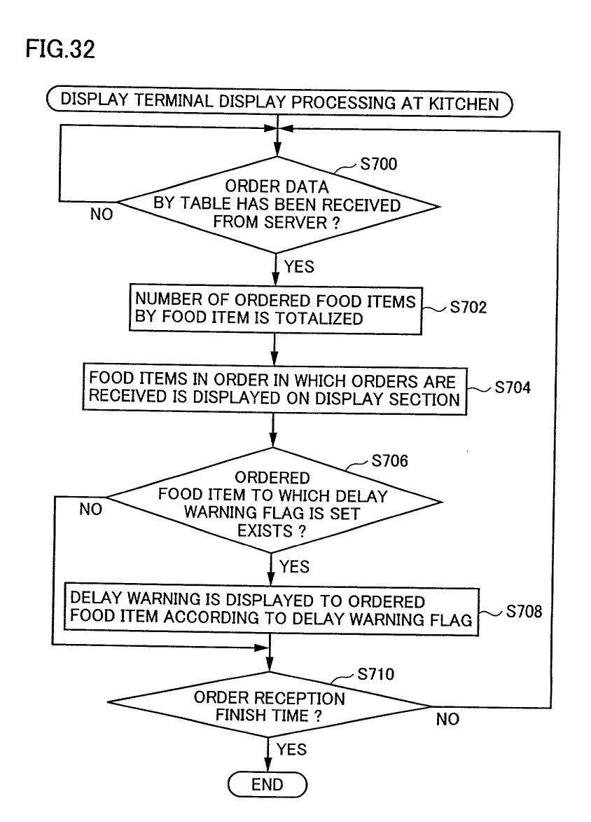

Referring to FIG. 32, a program executed in the kitchen display terminal 300 has the following control structure for display processing:

In S700, the CPU 302 determines whether or not the order data classified by table shown in FIG. 17 has been received from the server 400. If the order data classified by table has been received from the server 400 (in S700, determination is YES), the program proceeds to S702. If the order data classified by table has not been received from the server 400 (in S700, determination is NO), the program returns to S700, where awaited is the order data classified by table from the server 400.

In S702, the CPU 302 totalizes the number of ordered foods classified by food item. In S704, the CPU 302 displays ordered food items in the order in which orders are received on the display section 310.

In S706, the CPU 302 determines whether or not a food item to which a delay warning flag is set exists. If a food item to which the delay warning flag is set exists (in S706, determination is YES), the program proceeds to S708. If not (in S706, determination is NO), the program proceeds to S710.

In S708, the CPU 302 displays a delay warning on the display section 310 according to the delay warning flag.

In S710, the CPU 302 determines whether or not a current time point has reached the order reception finish time point. If the current time point has reached the order reception finish time point (in t710, determination is YES), this display processing is finished. If not (in S710, determination is NO), the program returns to S700 till a current time point reaches the order reception finish time point.

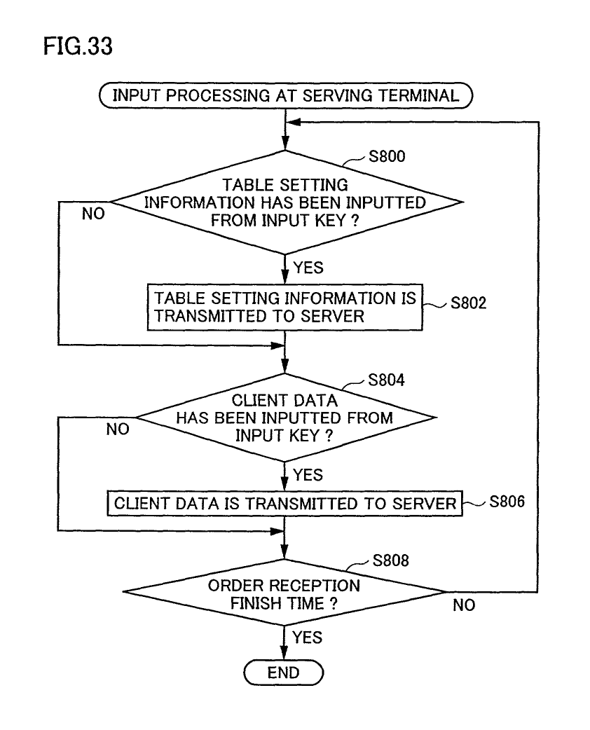

Referring to FIG. 33, a program executed in the serving terminal 200 has the following control structure for input processing:

In S800, the CPU 202 determines whether or not table setting information has been inputted from the input key 206. The table setting information in this processing is inputted before employees of the restaurant set food items having been cooked in the kitchen on a table. If the table setting information has been inputted from the input key (in S800, determination is YES), the program proceeds to S802. If not (in S800, determination is NO), the program proceeds to S804. In S802, the CPU 202 transmits the table setting information to the server 400.

In S804, the CPU 202 determines whether or not client data has been inputted from the input key 206. This processing is confirmed by employees in charge of table setting through visually checking in regard to sexes and age brackets of guests at each table when the employees in charge set ordered food items on a table, wherein an employee in charge inputs client data from the input key 206 on the basis of contents of the confirmation. If the client data has been inputted from the input key 206 (in S804, determination is YES), the program proceeds to S806. If not (in S804, determination is NO), the program proceeds to S808.

In S806, the CPU 202 transmits the client data to the server 400.

In S808, the CPU 202 determines whether or not a current time point has reached the order reception finish time point. If the current time point has reached the order reception finish time point (in S808, determination is YES), this input processing is finished. If not (in S808, determination is NO), the program returns to S800 till a current time point reaches the order reception finish time point.

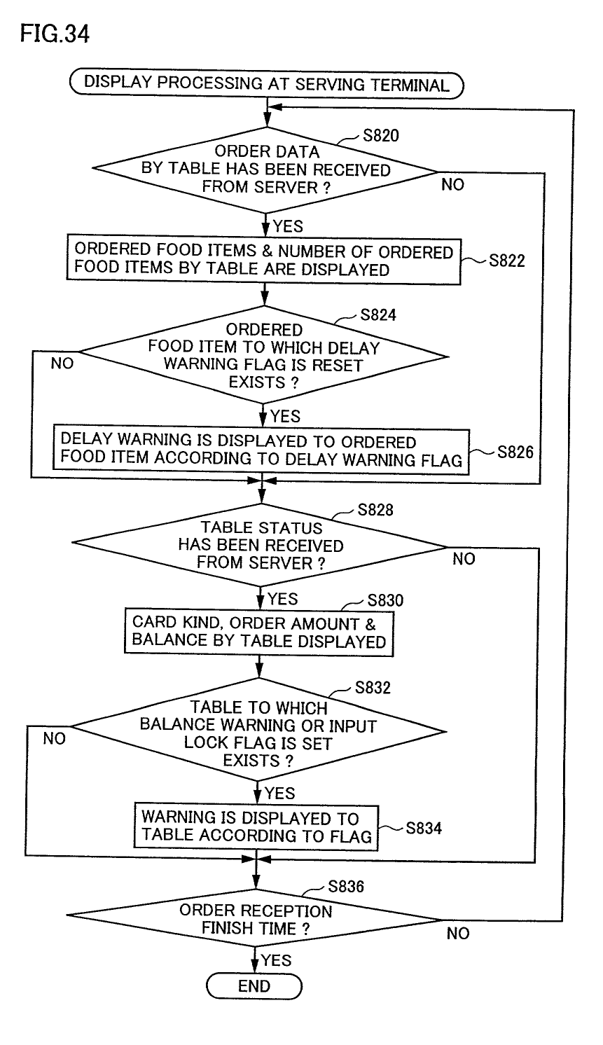

Referring to FIG. 34, the program executed in the serving terminal 200 has the following control structure for display processing:

In S820, the CPU 200 determines whether or not the order data classified by table shown in FIG. 17 has been received from the server 400. If the order data classified by table has been received from the server 400 (in S820, determination is YES), the program proceeds to S822. If not (in S820, determination is NO), the program proceeds to S828.

In S822, the CPU 202 displays ordered food items and the number of ordered food items at each table on the display section 210. In S824, the CPU 202 determines whether or not a food item to which a delay warning flag is set exists. If a food item to which a delay warning flag is set exists (in S824, determination is YES), the program proceeds to S826. If not (in S824, determination is NO), the program proceeds to S828.

In S826, the CPU 202 displays a delay warning according to the delay warning flag on the display section 210.

In S828, the CPU 202 determines whether or not the table status data shown in FIG. 18 has been received from the server 400. If the table status data has been received from the server 400 (in S828, determination is YES), the program proceeds to S830. If not (in S828, determination is NO), the program proceeds to S836.

In S830, the CPU 202 displays a kind of a card, an order amount and a balance at each table on the display section 210. In S832, the CPU 202 determines whether or not there exists a table to which a balance warning flag or an input lock flag is set. If there exists a table to which a balance warning flag or an input lock flag is set (in S832, determination is YES), the program proceeds to S834. If not (in S832, determination is NO), the program proceeds to S836.

In S834, the CPU 202 displays a warning on the display section 210 according to the balance warning flag or the input lock flag.

In S836, the CPU 202 determines whether or not a current time point has reached the order reception finish time point. If the current time point has reached the order reception finish time point (in S836, determination is YES), this display processing is finished. If not (in S836, determination is NO), the program returns to S820 till a current time point reaches the order reception finish time point.

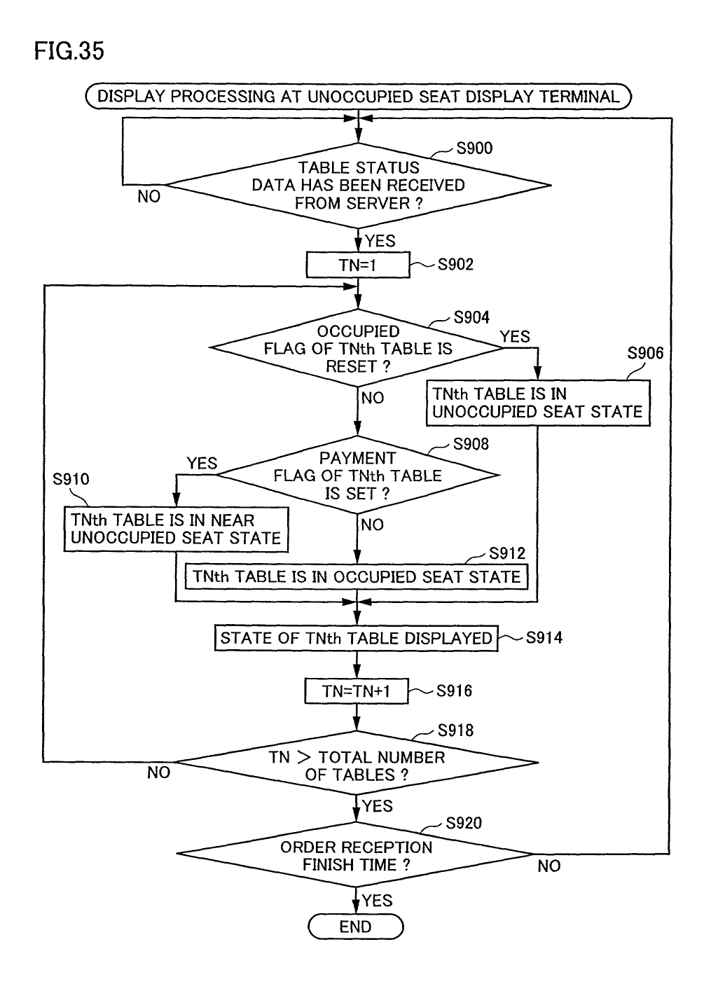

Referring to FIG. 35, a program executed in the unoccupied seat display terminal 500 has the following control structure for display processing:

In S900, the CPU 502 determines whether or not the table status data shown in FIG. 18 has been received from the server 400. If the table status data has been received from the server 400 (in S900, determination is YES), the program proceeds to S902. If not (in S900, determination is NO), the program returns to S900, where awaited is reception of the table status data from the server 400.

In S902, the CPU 502 initializes a variable TN indicating a table number (TN=1). In S904, the CPU 502 determines whether or not the occupied seat flag of a TNth table is reset. If the occupied seat flag of a TNth table is reset (in S904, determination is YES), the program proceeds to S906. If not (in S904, determination is NO), the program proceeds to S908.

In S906, the CPU 502 determines that a state of the TNth table is in an unoccupied seat state.

In S908, the CPU 502 determines whether or not a payment flag of the TNth table is set. If the payment flag of the TNth table is set (in S908, determination is YES), the program proceeds to S910. If not (in S908, determination is NO), the program proceeds to S912.

In S910, the CPU 502 determines that the state of the TNth table is a near unoccupied seat state.

In S912, the CPU 502 determines that the state of the TNth table is an occupied seat state.

In S914, the CPU 502 displays the state of the TNth table on the display section 510. In S916, the CPU 502 adds 1 to the variable TN.

In S918, the CPU 502 determines whether or not the variable TN is larger than a total number of all the tables installed in the restaurant. If the variable TN is larger than the total number of all the tables installed in the restaurant (in S918, determination is YES), the program proceeds to S920. If the variable TN is equal to or smaller than the total number of all the tables installed in the restaurant (in S918, determination is NO), the program returns to S904, where the CPU 502 determines a table state of a next table and displays the state of a next table on the display section 510.

In S920, the CPU 502 determines whether or not a current time point has reached the order reception finish time point. If the current time point has reached the order reception finish time point (in S920, determination is YES), this display processing is finished. If not (in S920, determination is NO), the program returns to S900.

Description will be given of operations of a restaurant management system on the basis of control structures and flow charts as described above:

Card Authentication Operation at Order Terminal

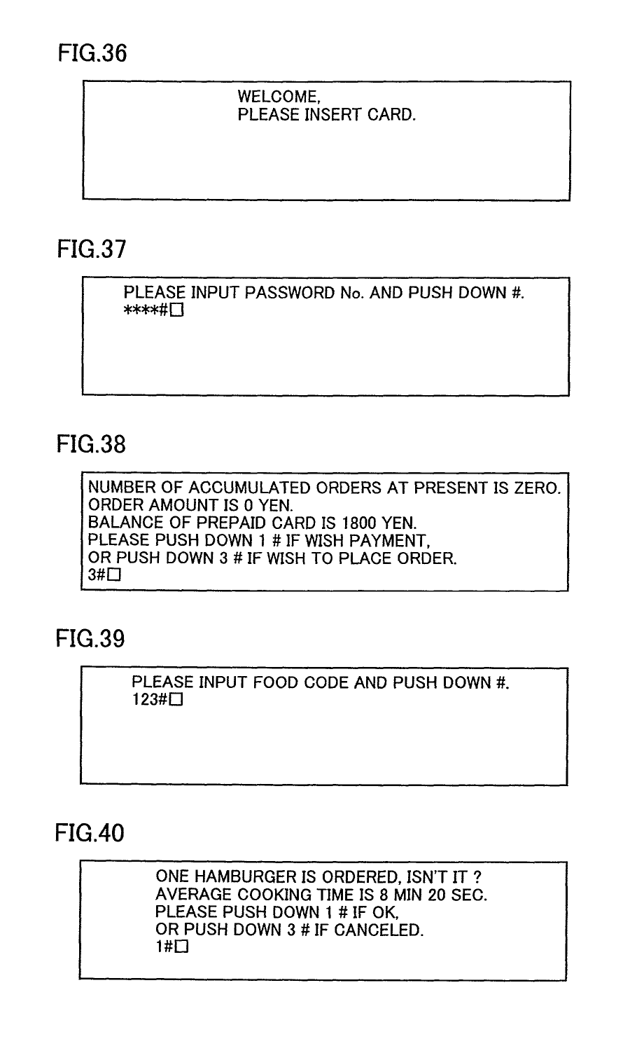

A guest, who visits a restaurant, takes a seat at a table whose unoccupied seat state is displayed according to a display of the unoccupied seat display terminal 500 described later. On the display section 110 of the order terminal 100 of the table, a screen image requesting insertion of a card as shown in FIG. 36 is displayed (S102). When the guest inserts a prepaid card or a credit card into the card read/write section 114, the order terminal 100 detects the insertion of a card (in S104, determination is YES) and reads data on the card (S106).

If the card inserted is a prepaid card or credit card (in S108, determination is YES), a screen image requesting input of a password number as shown in FIG. 37 is displayed on the display section 110 (S110). The guest inputs a password number and then [#] on the input key (in S112, determination is YES).

If the card inserted into the card read/write section 114 is a prepaid card (in S114, determination is YES), a password number and balance data are read out (S116). If the password number read out from the card and the password number inputted from the input key 106 coincide with each other (in S118, determination is YES) and the balance read out is larger than the lowest food unit price at the restaurant (in S120, determination is YES), the balance data shown in FIG. 8 is transmitted to the server 400 (S122). When the balance data is transmitted to the server 400, this card authentication operation is finished.

If the card inserted into the card read/write section 114 is a credit card (in S114, determination is NO), the authentication request data shown in FIG. 9 is transmitted to the server 400 (S124). If authentication data has been received till a predetermined time elapses after the authentication data was transmitted to the server 400 (in S126, determination is YES), the card authentication operation is finished.

Order Operation at Order Terminal

After the card authentication operation is finished, the number of accumulated orders, a money amount of the accumulated orders and a balance of the prepaid card at the present time are displayed as shown in FIG. 38 on the display section 110 of the order terminal 100. Note that when a credit card is inserted into the card read/write section 114, a balance according to a credit limit up to which payment can be effected with the credit card is displayed.

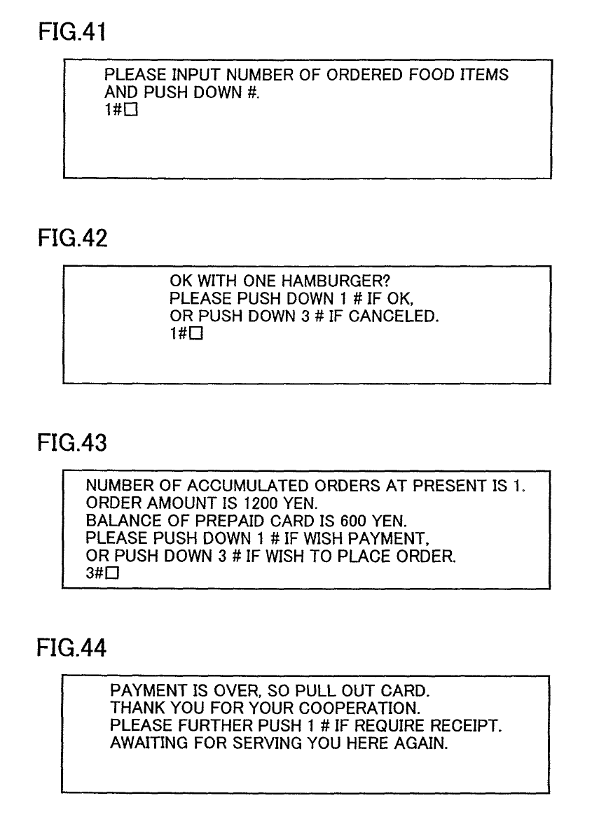

If the guest performs input to place a successive order (in S204, determination is YES), a screen image requesting input of a food code for a food item to be ordered is displayed as shown in FIG. 39 on the display section 110. If the food code and then [#] are inputted (in S208, determination is YES), a name of the food item and an average cooking time thereof are read from the memory 104 according to the food code inputted (S210) and the name of the food item and the average cooking time thereof are displayed as shown in FIG. 40 on the display section 110 (S212). If the guest performs input (in S214, determination is YES), a screen image requesting input of the number of food items is displayed as shown in FIG. 41 on the display section 110. If the guest inputs the number and then [#] (in S218, determination is YES), names of food items and the number thereof are displayed as shown in FIG. 42 on the display section 110 and a screen image requesting confirmation of the input is also displayed thereon. If the guest performs the input of confirmation, (in S222, determination is YES), the order data as shown in FIG. 11 is transmitted to the server 400 (S224).

If the order terminal 100 receives order confirmation data from the server 400 till a predetermined time elapses after the order data is transmitted to the server 400 (in S226, determination is YES), the display section 110 is displayed as shown in FIG. 43. The display section 110 displays a screen image requesting input of the number of accumulated orders at the present time, a money amount of the accumulated orders at the present time, a balance of prepaid card at the present time and information on whether or not an order is successively placed.

If input requesting payment is performed in such a state (in S300, determination is YES), the payment request data shown in FIG. 14 is transmitted to the server 400 (S400). If the payment confirmation data shown in FIG. 15 or 16 has been received from the server 400 till a predetermined time elapses after payment request data was transmitted to the server 400 (in S402, determination is YES), a payment operation is finished. Note that in a case of payment with a prepaid card, a balance is written on the prepaid card by the card read/write section 114 (S410).

Thereafter, the prepaid card or the credit card is pushed out from the card read/write section 114 (S412) and a screen image expressing completion of the payment is displayed as shown in FIG. 44. If a screen image confirming whether or not a receipt is necessary is displayed (S416) and input requesting the receipt is performed (S418), the receipt is printed in the printing section 112 (S420). [Authentication Operation at Server]

If the server 400 has received the balance data shown in FIG. 8 or the authentication request data shown in FIG. 9 from the order terminal 100 (in S500, determination is YES), the occupied seat flag of the table status shown in FIG. 18 is set (S502). If the authentication request data has received (in S506, determination is YES), a card number and a password number are transmitted to a server of a credit company (S508). If the server 400 has received authentication completion data from the server of the credit company till a predetermined time elapses after the card number and the password number were transmitted to the server of the credit company (in S510, determination is YES), authentication data shown in FIG. 10 is transmitted to the order terminal 100 from which the authentication request data has been transmitted (S512). A credit limit up to which payment can be effected with the credit card is set to the balance of the table status data shown in FIG. 18 (S516).

If data received from the order terminal 100 is balance data (S506, determination is YES), a balance on the prepaid card is set to the balance of the table status data shown in FIG. 18.

Order Operation at Server

If the order data shown in FIG. 11 has been received from the order terminal 100 (in S520, determination is YES), it is determined whether or not the input lock flag of the table status data shown in FIG. 18 is set. If the input lock flag is not set (in S522, determination is NO), the new balance is calculated (S524); and if the new balance is a positive value (in S526, determination is NO) and the balance is equal to or larger than a value of the lowest food unit price x the number of seats at a table of interest in the restaurant (in S528, determination is NO), a current time point is stored in order data classified by table as an order time point (S538).

If the new balance is negative, the order confirmation data shown in FIG. 12 is not transmitted to the order terminal 100. Furthermore, if the new balance is smaller than the value of the lowest food unit price x the number of seats at a table of interest in the restaurant (in S532, determination is YES), the balance warning flag is set (S530). If the new balance is the lowest food unit price in the restaurant (in S532, determination is YES), the input lock flag is set (S534). If the balance warning flag or the input lock flag is set, the table status data is transmitted to the serving terminal 200.

Delay Detection Operation at Server

Delay limit data for each food item stored on the fixed disk 424 is read out (S550). When a detection time point has reached (in S552, determination is YES), a passage time from an order time point till a current time point for a food item whose table setting time point has not been inputted is calculated on the basis of the order data classified by table shown in FIG. 17 (S554). If there is a food item whose passage time is equal to or longer than a limit time within which a delay is allowed (in S556, determination is YES), the delay warning flag is set for the food item in the order data classified by table shown in FIG. 17 (S558). The order data classified by table to which the delay warning flag is set is transmitted to the kitchen display terminal 300 and the serving terminal 200 (S560).

Calculation Operation for Cooking Time at Server

If an employee in charge of table setting inputs table setting information at the serving terminal 200 prior to table setting, the table setting information is transmitted from the serving terminal 200 to the server 400 in response to the table setting information inputted. The server 400 receives the table setting information from the serving terminal 200 (in S570, determination is YES). A current time point is stored in the order data classified by table shown in FIG. 17 as a table setting time point (S572) and a cooking time for a food item of interest is calculated on the basis of an order time point and the table setting time point (S574). The new average cooking time on which a newly calculated cooking time is reflected is calculated and stored (S576). If a transmit time point for an average cooking time has reached (in S578, determination is YES), the average cooking time is transmitted to the order terminals 100 and the unoccupied seat display terminal 500 (S580).

Payment Operation at Server

If the payment request data shown in FIG. 14 has been received from the order terminal 100 (in S600, determination is YES), a payment flag at a table of interest is set according to a table ID included in the payment request data (S602). Table status data is transmitted to the unoccupied seat display terminal 500 (S604).

If payment is effected with a credit card at a table specified by the table ID included in the payment request data (in S606, determination is YES), a payment money amount is calculated (S608) and a card number and the payment money amount are transmitted to a server of a credit company (S610). If the server 400 has received processing completion data from the server of a credit company till a predetermined time elapses after the server 400 transmitted the card number and the payment money amount to the server of a credit company (in S612, determination is YES), the payment confirmation data shown in FIG. 16 is transmitted to the order terminal 100 (S614).

If payment is effected with a prepaid card at a table specified by a table ID included in the payment request data (in S606, determination is NO), a balance is calculated (S618) and the payment confirmation data shown in FIG. 15 is transmitted to the order terminal 100 (S620).

Unoccupied Seat Processing Operation at Server

If a predetermined time has elapsed after a payment flag is set in the table status data shown in FIG. 18 (in S630, determination is YES), table status data of the table of the payment flag and order data classified by table are stored as totalized order data on the fixed disk 424 (S632). The occupied seat flag and the payment flag of the table in the table status data are reset (S634), which is transmitted to the unoccupied seat display terminal 500(S636).

Analysis Processing Operation at Server

If a current time point has reached a time point to perform analysis processing (in S650, determination is YES), the totalized order data shown in FIG. 20 is read out from the fixed disk 424 (S652). Analysis is performed on order data classified by time zone (S654), on order data classified by age bracket (S656) and on order data classified by sex (S658) on the basis of the totalized order data read out. Furthermore, incidence rates are calculated of delay warnings classified by time zone (S660) and incidence rates of delay warnings classified by ordered food item (S662).

Manual Operation at Serving Terminal

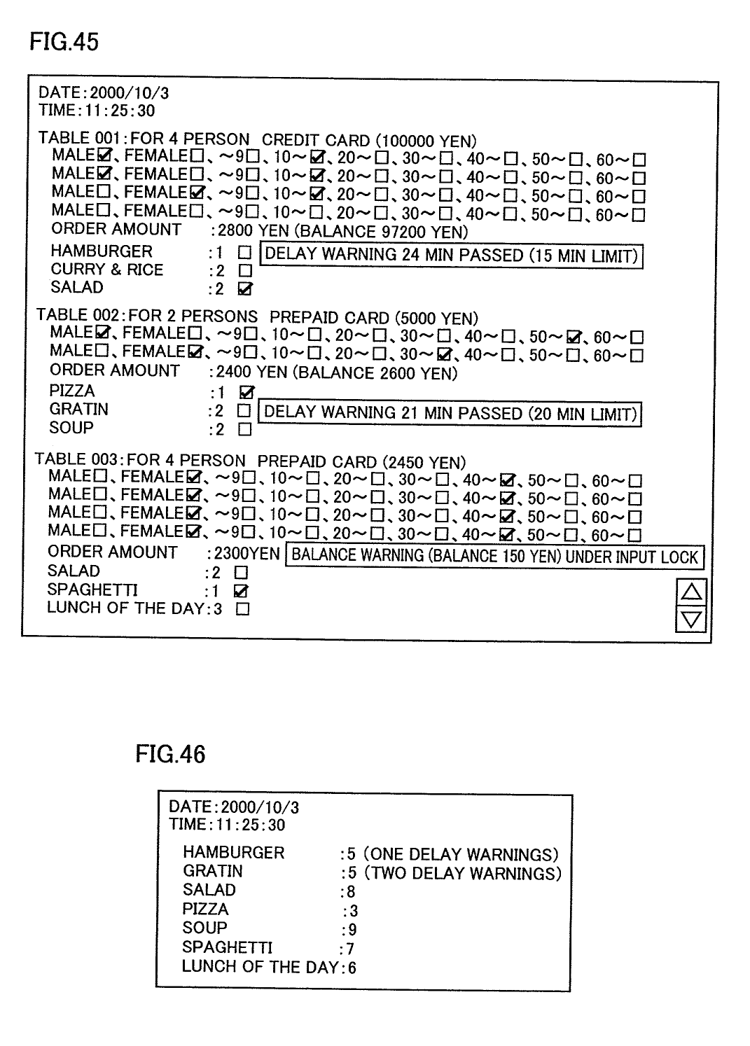

The display section 210 of the serving terminal 200, displays data classified by table as shown in FIG. 45. Furthermore, check boxes are displayed to each of which a sex of a guest is inputted and check boxes to each of which inputted is an age bracket to which the guest belongs in correspondence to the number of seats at each table. Still furthermore, names of ordered food items and the number thereof are displayed based on order data of each table. Yet furthermore, check boxes are displayed corresponding to the respective names of the ordered food items. Each check can be inputted by pressing a check box displayed on the display section 210 with a finger tip or a pen tip and the input can be canceled by a second pushing.

If table setting information has been inputted on the display section 210 shown in FIG. 45 (in S800, determination is YES), the table setting information is transmitted to the server 400 (S802). If an employee in charge of table setting pushes a check button for a cooked food item of interest before the cooked food items are set on a table, the table setting information is inputted.

If employees in charge of table setting visually confirm sexes and age brackets of guests at a table of interest and check the sex check boxes and age bracket check boxes shown in FIG. 45 when table setting is performed for cooked food items, client data is inputted (in S804, determination is YES). The inputted client data is transmitted to the server 400 (S806).

Display Operation at Serving Terminal

If the serving terminal 200 has received order data classified by table from the server 400 (in S820, determination is YES), names of ordered food items and the number thereof are displayed for each table as shown in FIG. 45 (S822). If there exists a food item to which a delay warning flag is set (in S824, determination is YES), a delay warning is displayed on the display section 210 according to the delay warning flag. For example, delay warning information is displayed for a hamburger at a table with a table ID of [001]. This is because while a limit time for a hamburger within which a delay is tolerated is 15 minutes, a time of 24 minutes has passed from an order time.

If table status data has been received from the server 400 (in S828, determination is YES), the display section 210 displays a kind of a card, a money amount of an order and a balance classified by table. If there exists a table to which a balance warning flag or an input lock flag is set (in S832, determination is YES), a warning is displayed on the display section 210 according to the flag (S834). For example, as shown in FIG. 45, a balance warning is displayed for a table with a table ID of [003] and it is also shown that an input lock flag is set.

Display operation at Kitchen Display Terminal

If the kitchen display terminal 300 has received order data classified by table from the server 400 (in S700, determination is YES), the number of orders are totalized while being classified by food item (S702) and names of food items are displayed on the display section 310 in the order in which the orders for food items are placed (S704). If there exists a food item to which a delay warning flag is set (in S706, determination is YES), a delay warning is displayed according to the delay warning flag (S708). A display example on the display section 310 of this kitchen display terminal 300 is shown in FIG. 46. In the display, presented for each food item are a total number of ordered food items and the number of ordered food items to each of which a delay warning has been issued.

Display Operation at Unoccupied Seat Display Terminal

If the unoccupied seat display terminal 500 has received table status data from the server 400 (in S900, determination is YES), a table number TN is initialized (S902). If an occupied seat flag of a first table is reset (in S904, determination is YES), it is determined that a state of the first table is in an unoccupied seat state (S906).

If an occupied seat flag of the first table is set (in S904, determination is NO) and a payment flag of the first table is set (in S908, determination is YES), it is determined that a state of the table is in a near unoccupied seat state (in S910).

If the occupied seat flag of the first table is set (in S904, determination is NO) and the payment flag of the first table is reset (in S908, determination is NO), it is determined that a state of the table is in an occupied seat state (S912). Thereafter, a state of the first table is displayed on the display section 510.

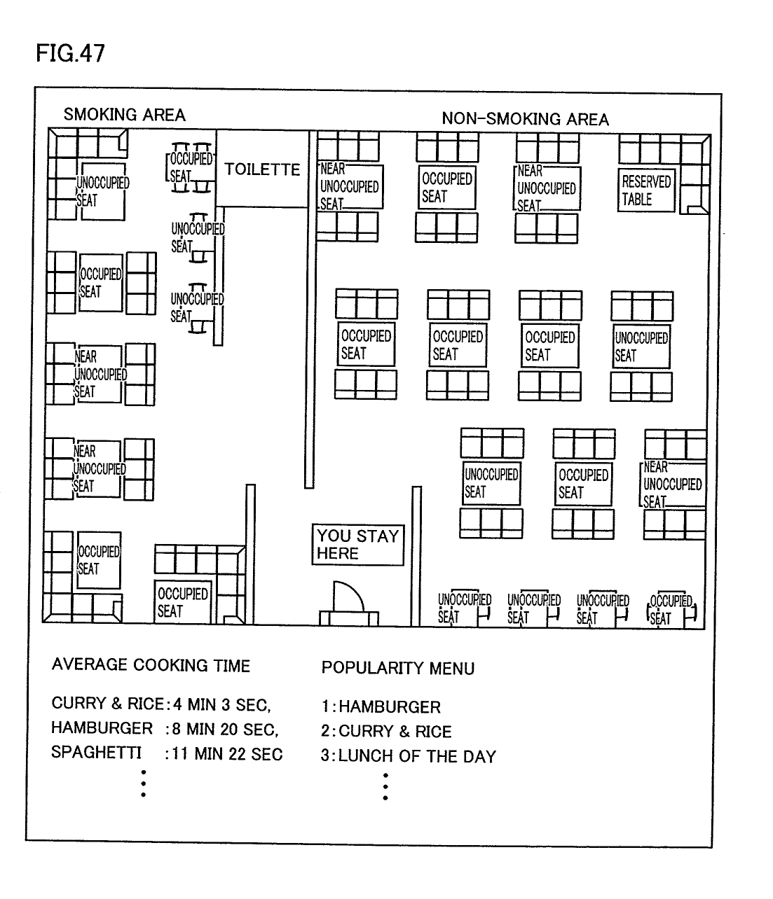

Such an operation is repeated on all the tables in the restaurant starting at the first table. As a result, a display is presented as shown in FIG. 47 on the display section 510 of the unoccupied seat display terminal 500. Average cooking times and a popularity menu may be displayed on the display section 510 as shown in FIG. 47.

According to a restaurant management system relating to the present embodiment, with configurations as described above, when a limit time elapses within which a delay is tolerated from an order time at which a food item is ordered using an order terminal placed on each table, a warning is issued in order that cooking and table setting are accelerated. Cooking is accelerated according to the warning to enable a waiting time that a guest suffers to decrease. Since an order is received on an order terminal within a range of money amount in which a guest can afford to spend, a charge can be surely acquired on the restaurant side. Furthermore, since guests are led to an unseated table using the unoccupied seat display terminal, orders are received from guests using an order terminal and payment is received using the order terminal, the number of employees can be reduced compared with a case where the operations are performed by hand. As a result, the restaurant management system can be provided in which a waiting time imposed on a guest required till a food item is set on a table after the guest arrives at a restaurant can be reduced to the shortest possible level with as small a number of employees as possible.

While in the above described embodiment, a restaurant management system including the server 400 is presented, there is no specific limitation to the system. Description will be given of a restaurant management system constructed of the order terminals 100 and the serving terminal 200.

In the restaurant management system, the order terminals 100 and the serving terminal 200 are connected mutually so as to communicate with each other. Constituents such as circuits of each of the order terminals 100 and the serving terminal 200 are the same as those in the above presented description; therefore, detailed descriptions thereof will not be repeated.

If order information has been inputted to an order terminal 100 by a guest, the order terminal 100 transmits the order information to the serving terminal 200. The serving terminal 200 displays the order information received on the display section 210 classifying the information by table. If table setting information has been inputted to the serving terminal 200 by an employee in charge of table setting in a restaurant, the serving terminal 200 displays the table setting information inputted on the display section 210 in relation to the order information.

On the serving terminal 200, the order information and the table setting information are displayed in a state of classification by table. An employee in charge of the table setting in this restaurant can extract a table whose order information is displayed but whose table setting information is not displayed with ease. Furthermore, the serving terminal 200 can perform detection processing for a delay which has been shown in the above presented description saying that the server 400 performs it. With such a configuration adopted, a warning to order information whose serving time has exceeded a predetermined time after ordering can be displayed on the serving terminal 200.

According to a restaurant management system relating to the embodiment, with configurations as described above, a food item whose serving time from a time point at which an order is placed by one of order terminals placed on respective tables exceeds an average waiting time is extracted and a warning is issued in order to accelerate cooking and table setting using the order terminal and the serving terminal. With the warning issued, cooking can be accelerated to reduce a waiting time imposed on a guest.

Second Embodiment

The second embodiment of the present invention is such that in addition to the first embodiment, a client computer or a portable telephone can be used to inquire about a state of unoccupied seats and make a reservation for seats in a restaurant. In the following description of the second embodiment, the same parts and boxes as those described above in the first example are attached by the same reference symbols; therefore detailed descriptions thereof will not be repeated.

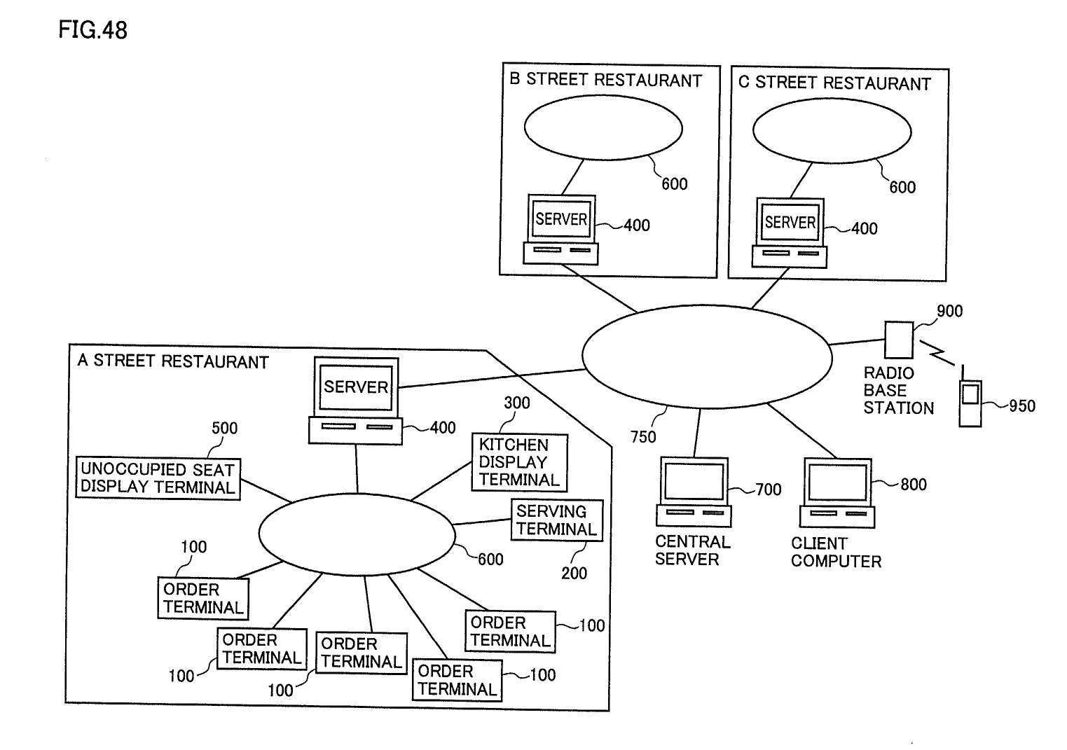

Referring to FIG. 48, the restaurant integral management system includes: a central server 700 managing so as to integrate a plurality of restaurants; a plurality of servers 400 managing the respective restaurants; a network 750 connecting the plurality of servers 400 and the central server 700; and a client computer 800 and a portable telephone 900 connected to the network 750 and inquiring the central server 700 of unoccupied seat information and making a reservation with the central server 700. Note that the portable telephone 900 is connected to the network 750 through a radio base station 950. The server 400 of each restaurant is connected to the order terminals 100, the serving terminal 200, the kitchen display terminal 300, the unoccupied seat display terminal 500 through the network 600 in the same way as the sever 400 is in the first embodiment. The following descriptions will be given in conjunction with the restaurant integral management system covering a plurality of restaurants in affiliation of the same family (an A-street branch restaurant, a B-street branch restaurant, a C-street branch restaurant and a D-street branch restaurant of a restaurant ABC).

The central server 700 is realized by the computer shown in FIGS. 5 and 6. The central server 700 has a similar configuration of the server 400. The central server 700 includes: a CPU 720 corresponding to the CPU 420; a memory 722 corresponding to the memory 422; a fixed disk 724 corresponding to the fixed disk 424; and a communication interface 726 corresponding to the communication interface 426. On the fixed disk 724, table status data of the plurality of restaurants are stored in relation to respective restaurant IDs identifying themselves.

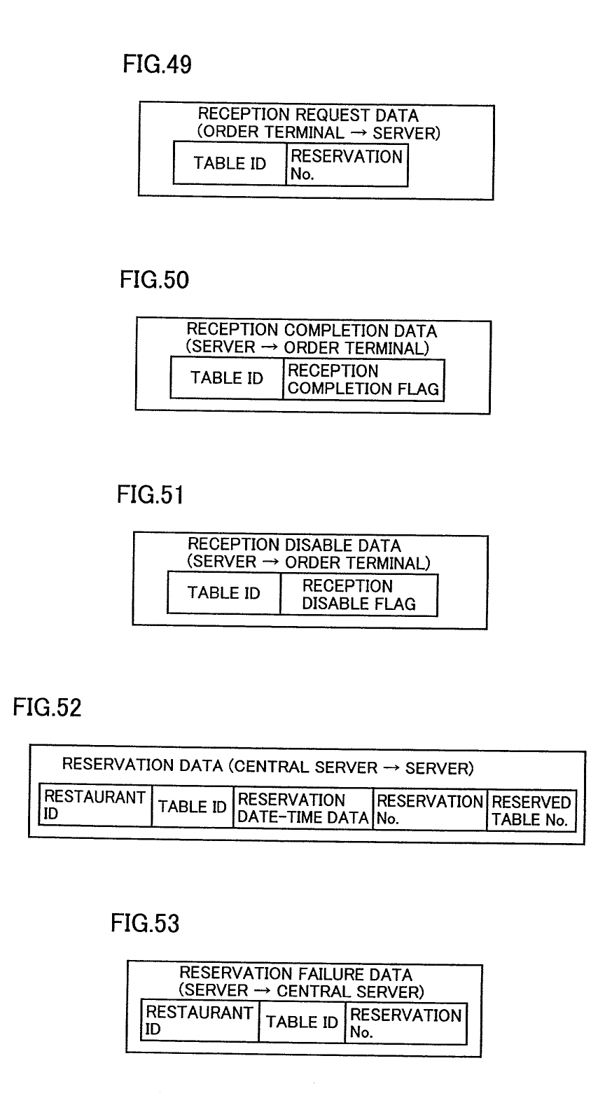

Referring to FIG. 49, reception request data transmitted to the sever 400 from the order terminal 100 includes: a table ID for uniquely specifying a table equipped with the order terminal 100 to which a reservation number is inputted by a reservation guest among a plurality of tables; and the reservation number which has been inputted from the input key of the order terminal 100 by the reservation guest. The reservation number is noticed to the reservation guest when the reservation has been made from the central server 700 through the client computer 800 or the portable telephone 900. A reservation guest visiting a restaurant inputs a reservation number using the input key 106 of the order terminal 100.

Referring to FIG. 50, reception completion data transmitted to an order terminal 100 from the server 400 includes a table ID and a reception completion flag. If the server 400 determines that a guest who has inputted a reservation number from the order terminal 100 is a guest who has made a reservation with the central server 700, the reception completion data is transmitted to the order terminal 100. The order terminal 100 detects that reception processing with the server 400 has been completed and performs the next processing.

Referring to FIG. 51, a reception disable data transmitted to the order terminal 100 from the server 400 includes a table ID and a reception disable flag. The reception disable data is transmitted to the order terminal 100 from the server 400 in the following cases: a case where a reservation number inputted from the order terminal 100 does not coincide with a reservation number stored in the server 400, and a case where a table equipped with the order terminal 100 to which a reservation guest inputs a reservation number does not coincide with a reservation table. The reception disable flag is transmitted to the order terminal 100 such that the order terminal 100 can discriminate non-coincidences between the reservation numbers or between the reservation tables. The order terminal 100 performs reception error processing on the basis of the received the reception disable data.

Referring to FIG. 52, a reservation data transmitted to a server 400 from the central server 700 includes: a restaurant ID for uniquely specifying a restaurant among the plurality of restaurants; a table ID; reservation date-time data; a reservation number; and a reservation table number. Reservation from the client computer 800 or the portable telephone 900 is processed by the central server 700 and the reservation data shown in FIG. 52 is transmitted to the server 400. The reservation number is generated so as to enable the central server 700 to uniquely specify a particular reservation among a plurality of reservations under control.

Referring FIG. 53, reservation failure data transmitted to the central server 700 from the server 400 includes: a restaurant ID; a table ID; and a reservation number. The server 400 determines that if an occupied seat flag has not been set even after a prescribed time elapses from a reservation date-time, the reservation has been failed. The server 400 performs processing to reset a reservation flag for the failed reservation or the like processing. The reservation that has been determined by the server 400 has been failed is transmitted to the central server 700 with the reservation failure data shown in FIG. 53. The central server 700 rewrites the reservation flag associated with the reservation failure of table status data stored on the fixed disk 724 and others.

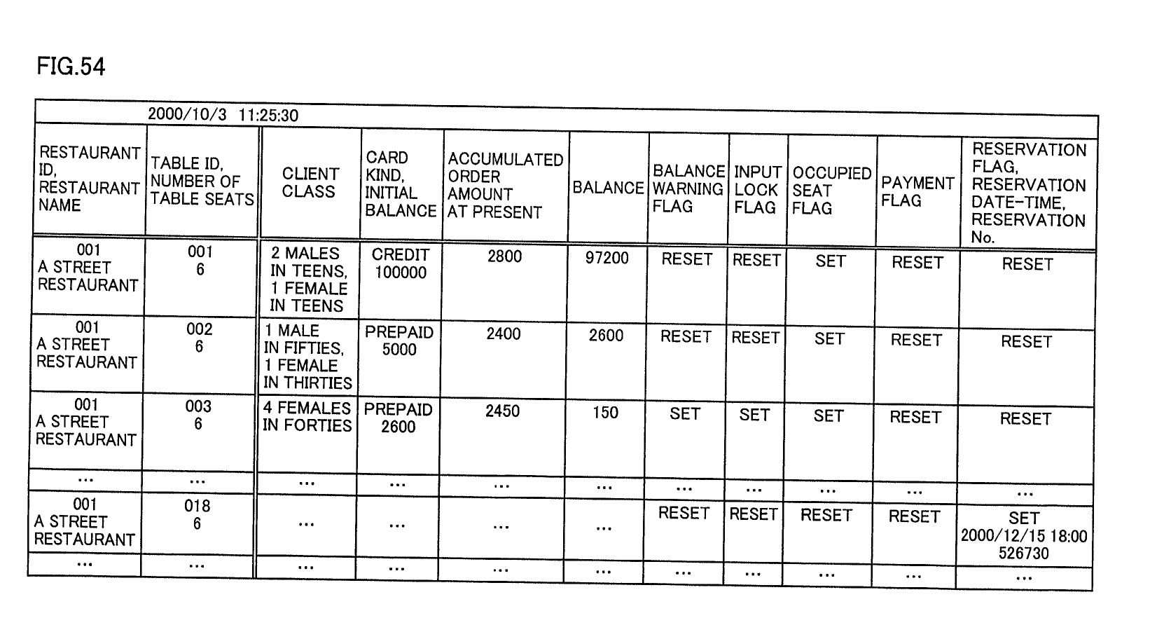

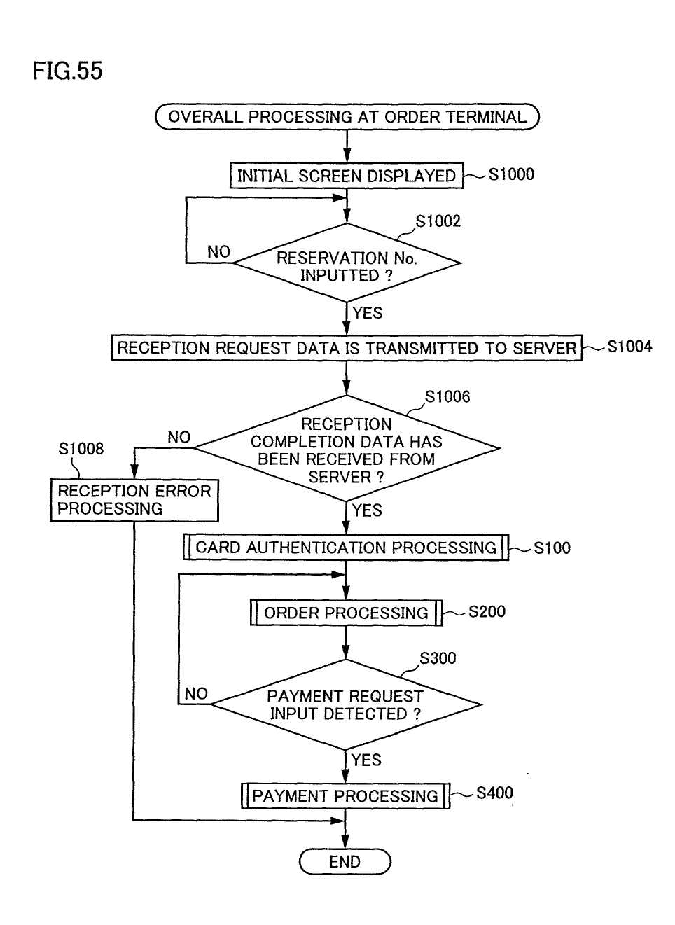

Referring to FIG. 54, table status data stored on the fixed disk 724 of the central server 700 includes: for each set of a restaurant ID and a table ID; a client guest class; a kind of a card; an initial balance; an accumulated amount at the present time; a balance, a balance warning flag, an input lock flag; an occupied seat flag; a payment flag; and a reservation related data (a reservation flag; a reservation date-time; and a reservation number).

A reservation flag is set to a table when it is an unseated table, satisfies a reservation time point and the number of members of a reservation party and can be retrieved by the central server 700 on the basis of reservation request data received from the client computer 800 or the portable telephone 900 and table status data received from a server 400. The reservation date-time and the number of members of a reservation party are included in reservation request data.

Referring to FIG. 55, a program executed in the order terminal 100 has the following structure for overall processing. The overall processing is such that reception processing is performed prior to S100 of FIG. 18 in the first embodiment described above. The other processing is the same as that of the first embodiment; therefore, detailed description will not be repeated here.

In S1000, the CPU 102 displays an initial screen image on the display section 110. This screen image requests input of a reservation number.

In S1002, the CPU 102 determines whether or not input of a reservation number has been detected. This determination is performed according to whether or not the reservation number and a prescribed button are pushed down from the input key 106. If input of the reservation number has been detected (in S1002, determination is YES), the program proceeds to S1004. If no input of the reservation number has been detected (in S1002, determination is NO), the program returns to S1002, where input of the reservation number is awaited. In S1004, the CPU 102 transmits the reception request data shown in FIG. 49 to the server 400.

In S1006, the CPU 102 determines whether or not reception completion data has been received from the server 400. At this time, one of the reception completion data shown in FIG. 50 and the reception disable data shown in FIG. 51 is transmitted to the order terminal 100 from the server 400. If the reception completion data has been received (in S1006, determination is YES), the program proceeds to S1000. If not (in S1006, determination is NO), the program proceeds to S1008.

In S1008, the CPU 102 performs reception error processing. This processing is to perform a prescribed display on the display section 110 according to the reception disable flag of the reception disable data. If the reception disable flag is a flag indicating a case where non-coincidence arises between a reservation number inputted and a reservation number of table status data on the fixed disk of the server 400, a statement saying “since the reservation number is wrong, the reservation cannot be received” is displayed on the display section 110. If the reception disable flag is a flag indicating a case where a table number of a table equipped with an order terminal 100 from which a reservation number is inputted does not coincide with a reservation table specified by a reservation number inputted, a statement saying “since the reservation table is wrong, the reservation cannot be received” is displayed on the display section 110.

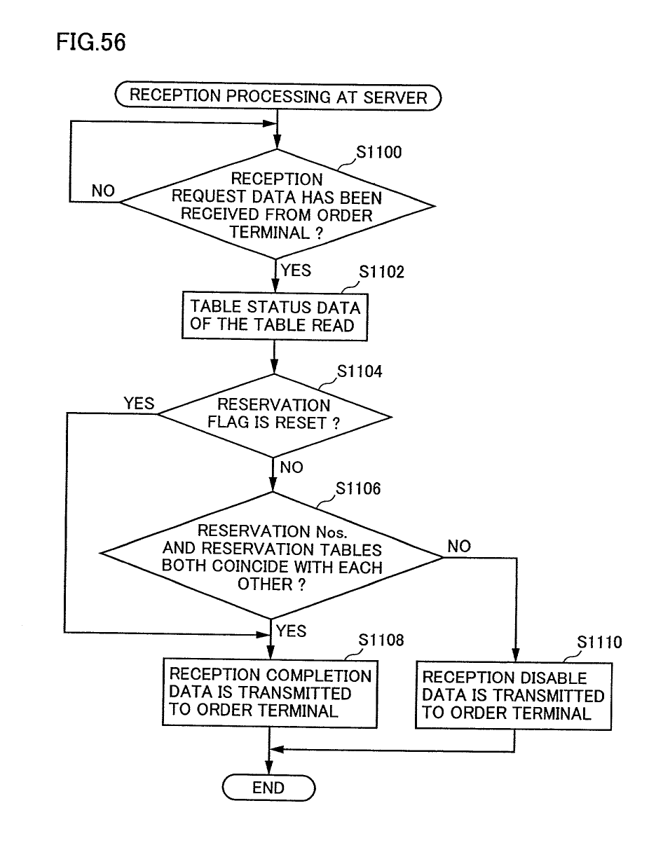

Referring to FIG. 56, a program executed on the server 400 has the following control structure for reception processing.

In SI 100, the CPU 420 determines whether or not the reception request data shown in FIG. 49 has been received from the order terminal 100. If the reception request data has been received (in S1100, determination is YES), the program proceeds to S1102. If the reception request data has not been received (in S1100, determination is NO), the program returns to S1100, where reception of the reception request data is awaited.

In S1102, the CPU 402 reads out table status data specified by a table ID included in reception request data from the fixed disk 424. In S104, the CPU 420 determines whether or not a reservation flag of the table status data read out is reset. If the reservation flag is reset (in S1104, determination is YES), the program proceeds to S1108. If the reservation flag is set (in S1104, determination is NO), the program proceeds to S1106.

In S1106, the CPU 420 determines whether or not a reservation number of the reservation data received and a reservation number of the table status data read out coincide with each other, and whether or not a table ID of the reservation data received and a table ID to which the received reservation number is set coincide with each other. If the reservation numbers coincide with each other and the table IDs coincide with each other (in S1106, determination is YES), the program proceeds to S1108. If the reservation numbers does not coincide with each other or the table IDs coincide with each other (in S1106, determination is NO), the program proceeds to S1110.

In S1108, the CPU 420 transmits the reception completion data shown in FIG. 50 to the order terminal 100 from which reception request data has been transmitted. In S1110, the CPU 420 transmits the reception disable data shown in FIG. 51 to the order terminal 100 from which reception request data has been transmitted.

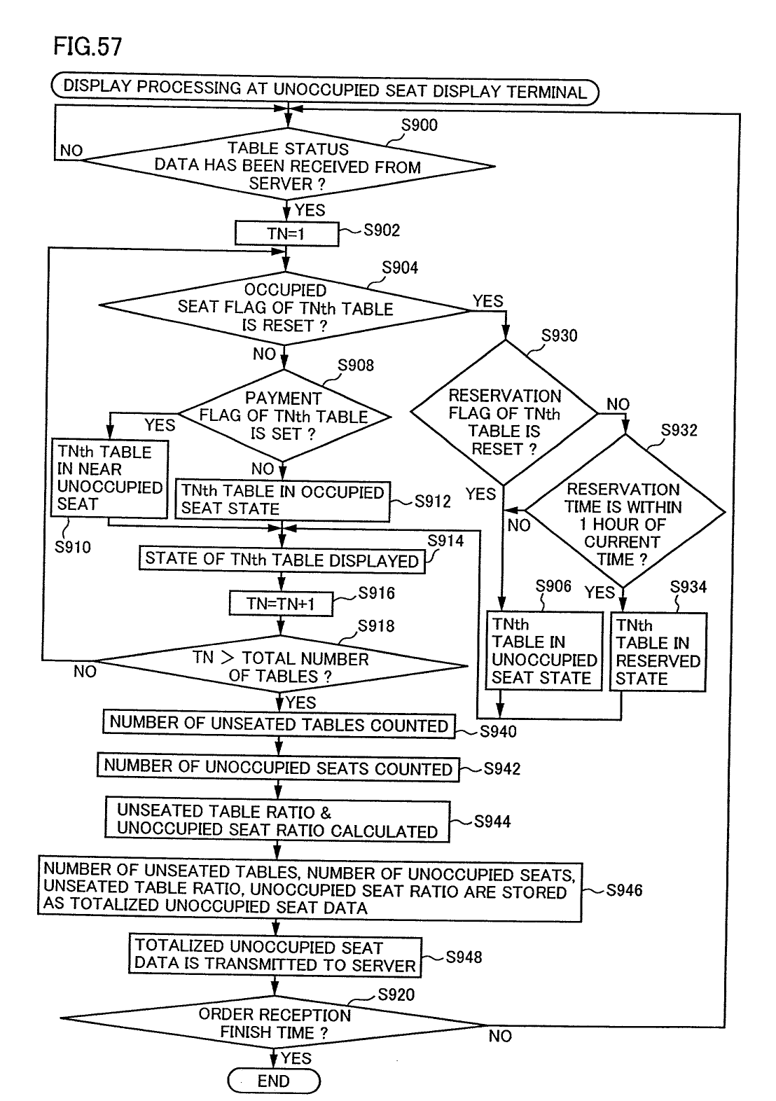

Referring to FIG. 57, a program executed in the unoccupied display terminal 500 has the following control structure for display processing. The processings are presented in the following description, which includes: processing described below from S930 to 934 performed prior to S906 of FIG. 35 in the first embodiment described above; and furthermore processing described below from S940 to S948 performed prior to S920 of FIG. 35 in the first embodiment. The other processings are the same as that of the first embodiment; therefore, detailed descriptions thereof will not be repeated here.

In S904, if the occupied seat flag of a TNth table TN is reset (in S904, determination is YES), in S930 the CPU 502 determines whether or not the reservation flag of the TNth table is reset. If the reservation flag of the TNth table is reset (in S930, determination is YES), the program proceeds to S906. If the reservation flag of the TNth table is set (in S930, determination is NO), the program proceeds to S932.

In S932, the CPU 502 determines whether or not a current time point is within one hour to go till a reservation date-time. If the current time point is within one hour to go till the reservation date-time (in S932, determination is YES), the program proceeds to S934. If the current time point is before one hour to go till the reservation date-time (in S932, determination is NO), the program proceeds to S906.

In S934, the CPU 502 determines that the TNth table is in a reserved state.

In S918, if the variable TN is larger than a total number of tables (in S918, determination is YES), in S940 the CPU 502 counts the number of tables which the CPU 502 determines unseated (the number of unseated tables). In S942, the CPU 520 counts the number of unoccupied seats on the basis of tables which the CPU 520 determines unseated. In S944, the CPU 520 calculates a ratio of the number of unseated tables to a total number of all tables in this restaurant (an unseated table ratio) and a ratio of the number of unoccupied seats to a total number of all seats in this restaurant (an unoccupied seat ratio).

In S946, the CPU 502 stores the number of unseated tables and the number of unoccupied seats, both having been counted, and the unseated table ratio and the unoccupied seat ratio, both having been calculated, as totalized unoccupied seat data in the memory 504. In S948, the CPU 502 transmits the totalized unoccupied seat data to the sever 400.

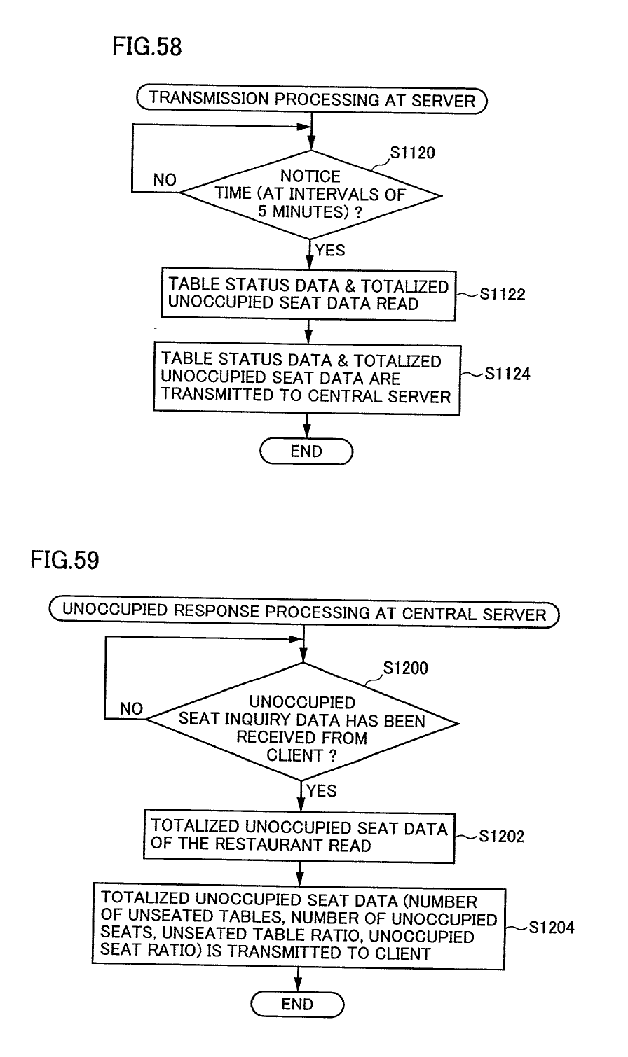

Referring to FIG. 58, a program executed in the server 400 has the following structure for transmit processing:

In S120, the CPU 420 determines whether or not a current time point has reached a notice time point. Notice time points are set, for example, at intervals of 5 minutes. If the current time point is a notice time point (in S1120, determination is YES), the program proceeds to S1122. If the current time point is not a notice time point (in S1120, determination is NO), the program returns to S1120, where a notice time is awaited.

In S1122, the CPU 420 reads out table status data and totalized unoccupied seat data from the fixed disk 724. In S1124, the CPU 420 transmits the table status data and the totalized unoccupied seat data to the central server 700 together with a restaurant ID. Such processing is repeated till a current time point reaches an order reception finish time point and table status data and totalized unoccupied seat data are transmitted at each notice time point coming to the central server 700.

Note that the central server 700 having received the table status data and the totalized unoccupied seat data stores the table status data and the totalized unoccupied seat data on the fixed disk 724 classifying both of the data by restaurant ID.

Referring FIG. 59, a program executed in the central server 700 has the following control structure for unoccupied seat response processing:

In S1200, the CPU 720 determines whether or not unoccupied seat inquiry data has been received from the client computer 800 or the portable telephone 900. The unoccupied seat inquiry data received at this time includes a restaurant ID for uniquely specifying one restaurant among the plurality of restaurants. If the unoccupied seat inquiry data has been received (in S1200, determination is YES), the program proceeds to S1202. If not (in S1200, determination is NO), the program returns to S1200, where reception of unoccupied seat inquiry data is awaited.

In S1202, the CPU 720 reads out totalized unoccupied seat data of a restaurant specified by a restaurant ID in the unoccupied seat inquiry data received from the fixed disk 724. In S1204, the CPU 720 transmits the totalized unoccupied seat data read out from the fixed disk 724 to the client computer 800 or the portable telephone 900 from which the unoccupied seat inquiry data has been transmitted.

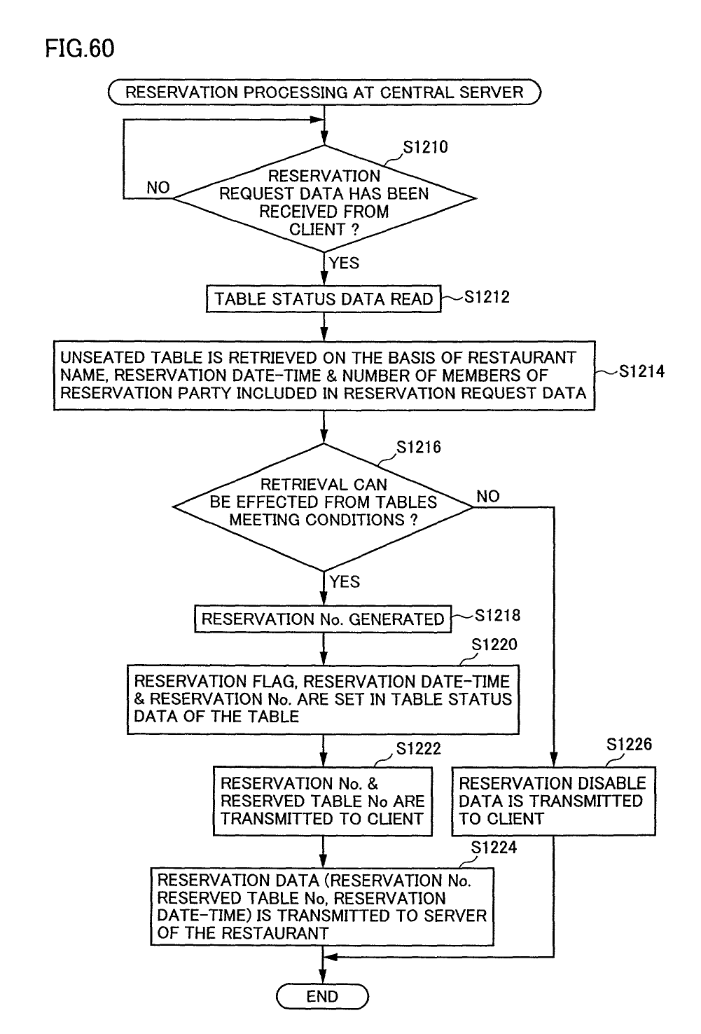

In referring to FIG. 60, the program executed in the central server 700 has the following control structure for reservation processing:

In S1210, the CPU 720 determines whether or not reservation request data has been received from the client computer 800 or the portable telephone 900. The reservation request data received at this time includes: a restaurant ID for specifying a restaurant for which a guest desires to make a reservation; a reservation date-time; and the number of members of a reservation party. If the reservation request data has been received (in S1210, determination is YES), the program proceeds to S1212. If not (in S1210, determination is NO), the program returns to S1210, where reception of reservation request data is awaited.

In S1212, the CPU 720 reads out table status data of a restaurant specified by a restaurant ID included in the received reservation request data from the fixed disk 724. In S1214, the CPU 720 retrieves a table being unseated at a reservation date-time included in the reservation request data and having the number of seats covering the number of members of a reservation party, in the table status data read out from the fixed disk 724.

In S1216, the CPU 720 determines whether or not a table that has conditions satisfying the reservation request data has been retrieved. If the table that has the conditions satisfying the request data has been retrieved (in S1216, determination is YES), the program proceeds to S1218. If the table that has the conditions satisfying the request data has not been retrieved (in S1216, determination is NO), the program proceeds to S1226.

In S1218, the CPU 720 generates a reservation number. In S1220, the CPU 720 sets a reservation flag, a reservation date-time and the reservation number in table status data of the table meeting the conditions. In S1222, the CPU 720 transmits the reservation number and a reservation table number to the client computer 800 and the portable telephone 900 from which the reservation request data has been transmitted.

In S1224, the CPU 720 transmits the reservation data shown in FIG. 52 to the server 400 installed in the restaurant of the reservation request data. In S1226, the CPU 720 transmits reservation disable data indicating that reservation can not be made to the client computer 800 or portable telephone 900 from which the reservation request data has been transmitted.

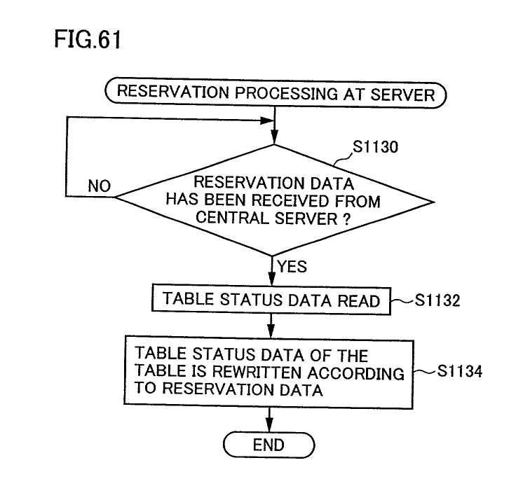

Referring to FIG. 61, a program executed in the server 400 has the following control structure for reservation processing:

In S1130, the CPU 420 determines whether or not the reservation data shown in FIG. 52 has been received from the central server 700. If the reservation data has been received (in S1130, determination is YES), the program proceeds to S1132. If not (in S1130, determination is NO), the program returns to S1130, where reception of reservation data is awaited.

In S1132, the CPU 420 reads out table status data from the fixed disk 424. In S1134 the CPU 420 rewrites the table status data of the table of the reservation data according to the reservation data received.

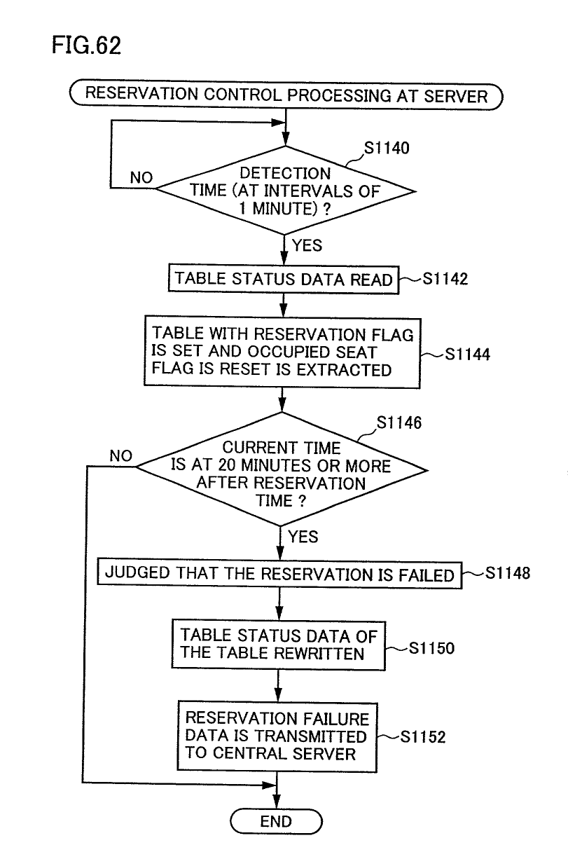

Referring to FIG. 62, the program executed in the server 400 has the following control structure for reservation control processing:

In S1140, the CPU 420 determines whether or not a current time point has reached a detection time point. The detection time point are set, for example at intervals of one minute. If the current time point is the detection time point (in S1140, determination is YES), the program proceeds to S1142. If not (in S1140, determination is NO), the program returns to S1140, where a detection time is awaited.

In S1142, the CPU 420 reads out table status data form the disk 424. In S1144, the CPU 420 extracts a table with a reservation flag that is set and with an occupied seat flag that is reset. In S1146, the CPU 420 determines whether or not a current time point is at 20 minutes or more after a reservation date-time. If the current time point is at 20 minutes or more thereafter (in S1146, determination is YES), the program proceeds to S1148. If not (in S1146, determination is NO), this reservation control processing is finished. Such processing is repeated until a current time point reaches an order reception finish time point, where it is determined whether or not a passage time after the reservation date-time is equal to or more than a predetermined time at each detection time point.

In S1148, the CPU 420 determines that a reservation with the reservation flag that is set and the occupied seat flag that is reset is a reservation failure. In S1150 the CPU 420 resets reservation related data (a reservation flag, a reservation date-time and a reservation number) of the table status data of the table.

In S1152, the CPU 420 transmits the reservation failure data shown in FIG. 53 to the central server 700.

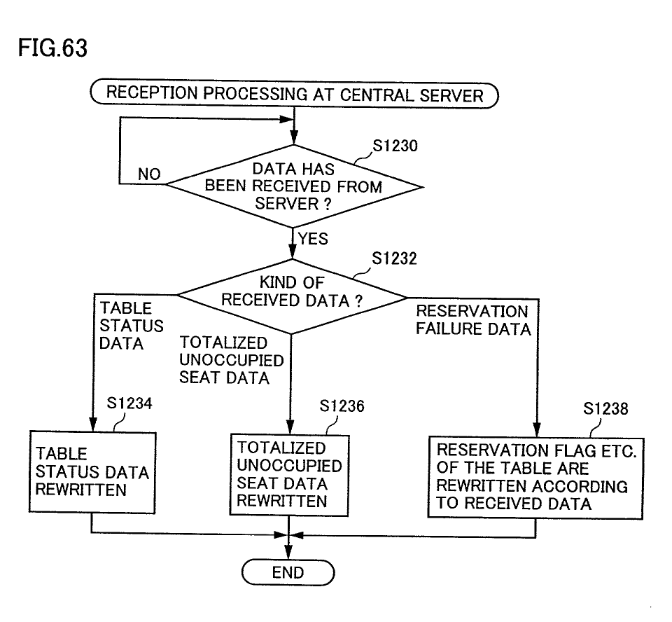

Referring to FIG. 63, the program executed in the central server 700 has the following control structure for reception processing:

In S1230, the CPU 720 determines whether or not data has been By-; received from the server 400. The data received at this time is one of table status data, totalized unoccupied seat data and reservation failure data. If the data has been received (in S1230, determination is YES), the program proceeds to S1232. If not (in S1230, determination is NO), the program returns to S1230, where reception of data is awaited.

In S1232, the CPU 720 determines a kind of the data received. If the data received is table status data, the program proceeds to S1234. If the data received is totalized unoccupied seat data, the program proceeds to S1236. If the data received is reservation failure data, the program proceeds to S1238.

In S1234, the CPU 720 rewrites table status data of the restaurant with the server 400 according to the table status data received. In S1236, the CPU 720 rewrites totalized unoccupied seat data of the restaurant according to the totalized unoccupied seat data received. In S1238, the CPU 720 rewrites the reservation flag and others of the restaurant and the table of the received data according to the reservation failure data received.

Description will be given of operations of a restaurant integral management system according to control structures and flow charts as described above.

Unoccupied Seat Inquiry Operation by Portable Telephone

Description will be given of an operation in which a guest desires to visit a restaurant inquires in advance the central server 700 of a level of congestion in a restaurant with the portable telephone 900. In the following description, an unoccupied seat display terminal 500 calculates totalized unoccupied seat data (the number of unseated tables, the number of unoccupied seats, an unseated table ratio and an unoccupied seat ratio) and transmits the data to the server 400, and the server 400 transmits totalized unoccupied seat data to the central server 700 to store the totalized unoccupied seat data classifying the data by restaurant ID on the fixed disk 724 of the central server 700.

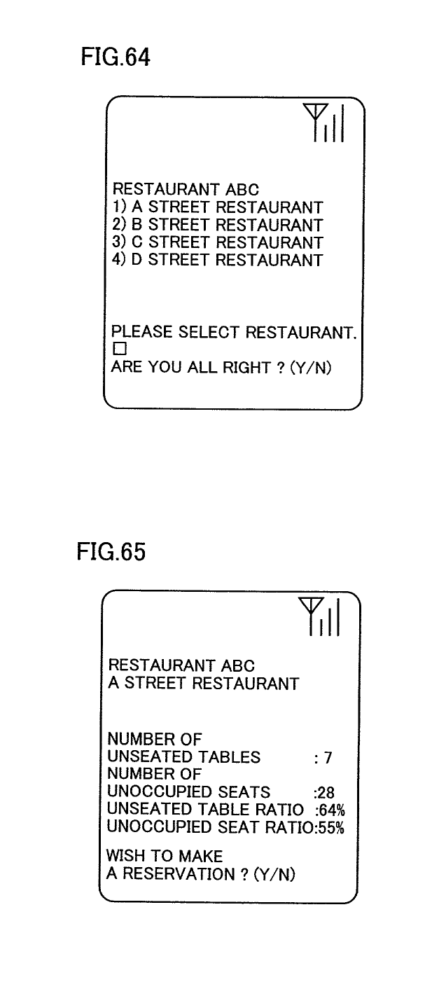

When a user of the portable telephone 900 places a call to a prescribed phone number from the portable telephone 900, the portable telephone 900 and the central server 700 are connected to each other through the radio base station 950. Restaurant information of the restaurant ABC is transmitted to the portable telephone 900 from the central server 700 to display the screen image shown in FIG. 64 on the portable telephone 900.

A restaurant is selected by the user of a portable telephone 900 and if unoccupied seat inquiry data has been transmitted to the central server 700, the central server 700 receives the unoccupied inquiry data (in S1200, determination is YES). Totalized unoccupied seat data of the restaurant selected by the user of the portable telephone 900 is read out from the fixed disk 724 (S1202). The totalized unoccupied seat data read out is transmitted to the portable telephone 900 (S1204).

The screen image shown in FIG. 65 is displayed on the portable telephone 900 which has received the totalized unoccupied seat data. Thereby, the totalized unoccupied seat data is displayed on the portable telephone 900 and a level of congestion at the restaurant can be understood.

Reservation Operation by Portable Telephone

Description will be given of an operation in which a guest desiring a visit to a restaurant makes a reservation with the central server 700 using the portable telephone 900.

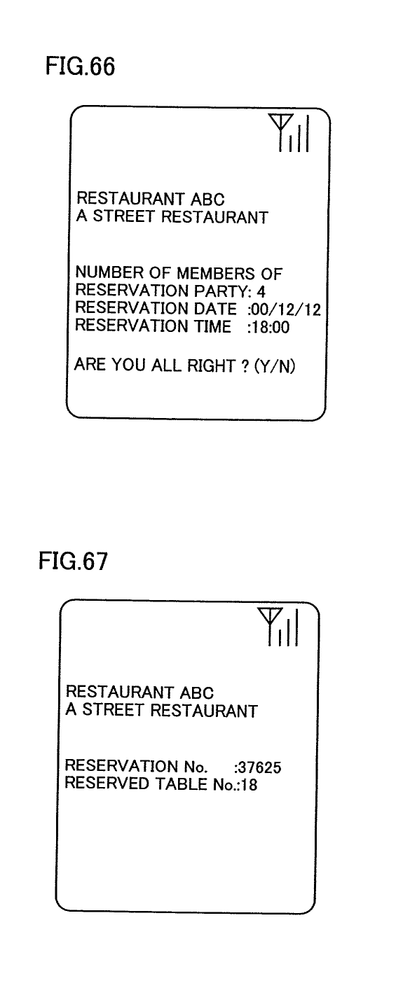

When reservation is requested using the portable telephone 900 on which the screen image shown in FIG. 65 is displayed, data expressing a reservation input screen image is transmitted to the portable telephone 900 from the central server 700. The screen image shown in FIG. 66 is displayed on the portable telephone 900. If the number of members of a reservation party and a reservation date-time have been inputted by the user of the portable telephone 900 and the reservation request data (the number of members of a reservation party and the reservation date-time) has been transmitted to the central server 700, the central server 700 receives the reservation request data (in S1210, determination is YES).

Table status data of the restaurant is read out by the central server 700 (S1212), an unseated table is retrieved in the table status data on the basis of the reservation date-time and the number of members of the reservation party (S1214). If an unseated table can be retrieved (in S1216, determination is YES), a reservation number is generated. A reservation flag, the reservation date-time and the reservation number are set to the unseated table retrieved in the table status data of the fixed disk 724 of the central server 700 (S1220). The reservation number and the reservation table number are transmitted to the portable telephone 900 by the central server 700 (S1222) to display the screen image shown in FIG. 67 on the portable telephone 900. The reservation data (the reservation number, the reservation table number and the reservation date-time) is transmitted to the server 400 of the restaurant by the central server 700 (S1224).

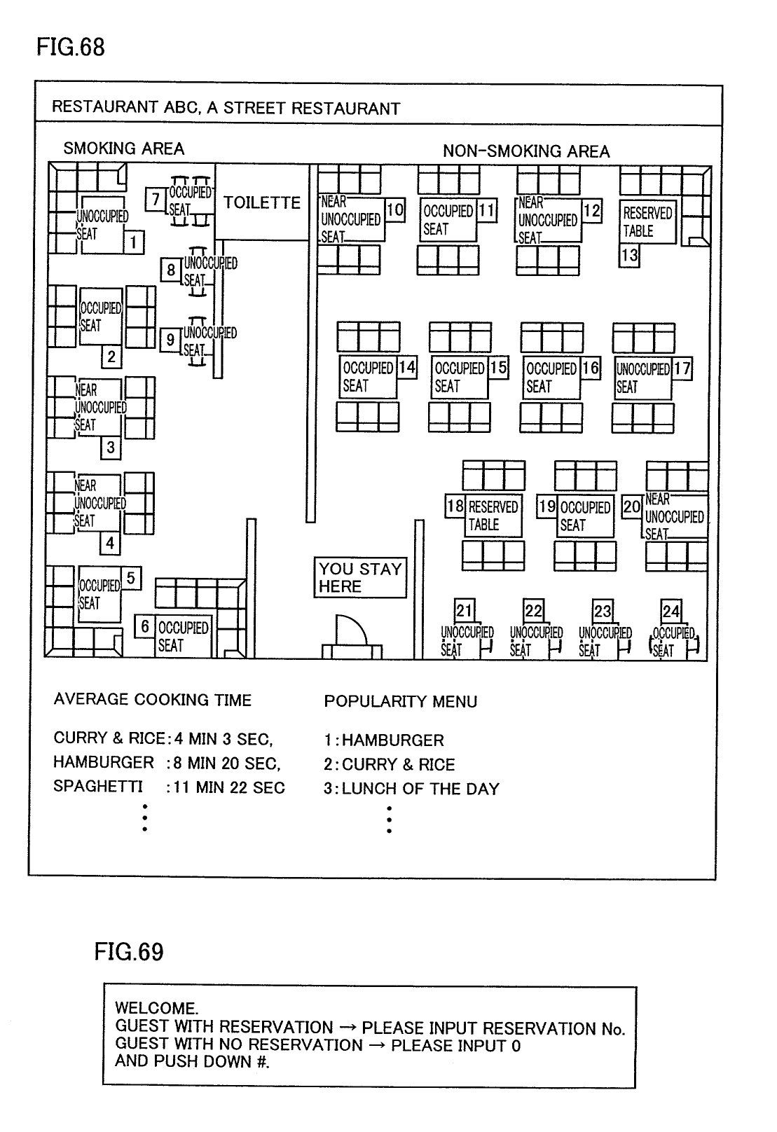

The guests who have made a reservation for the restaurant using the portable telephone 900 visit the A-street restaurant of the restaurant ABC, already reserved. The unoccupied seat display terminal 500 is installed at the entrance of the restaurant and the screen image shown in FIG. 68 is displayed thereon. The guests of the reservation can grasp a position of a reserved table on the basis of this display and the reservation table number.

When the reservation guests arrive at the reserved table, the screen image has already been displayed on the order terminal 100 placed on the table (S1000). If one of the guest inputs the reservation number using the order terminal 100 (in S1002, determination is YES), the reception request data is transmitted to the server 400 by the order terminal 100 (S1204).

If the server 400 has received the reception request data (in S1100, determination is YES), table status data of the table is read out from the fixed disk 424 (S1102). If a reservation flag is set (in S1104, determination is NO), and the reservation numbers and the reservation table numbers coincide with each other in respective cases (in S1106, determination is YES), reception completion data is transmitted to the order terminal 100 from the server 400 (S1108).

If the order terminal 100 has received the reception completion data (in S1006, determination is YES), card authentication processing is performed by the order terminal 100.

While in the above presented description, a restaurant specified by a restaurant ID included in a reservation request data is retrieved, there is no specific limitation to the restaurant. An unseated table is retrieved on the basis of table status data of restaurants other than one specified by a restaurant ID included in the reservation request data, a reservation date time and the number of members of a reservation party, prior to the processing of S1226. As a result of the retrieval, if a table satisfying the reservation conditions can be retrieved, transmission can be performed to the effect that a table can be reserved in the other restaurants to the client computer 800 or the portable telephone 900.

While in the above presented description, an inquiry about a state of unseated tables in a restaurant or a reservation for seats in a restaurant is performed through the client computer 800 or the portable telephone 900 with a central server 700, there is no specific limitation to this procedure. It is also allowed that an inquiry about a state of unseated tables in a restaurant or a reservation for seats is performed through the client computer 800 or the portable telephone 900 directly with the server 400 instead of the central server 700. In this case, the table status data and totalized unoccupied seat data covering a particular restaurant managed by the server 400 are stored on the fixed disk 424 of the server 400. Each server 400 transmits totalized unoccupied seat data stored on the fixed disk 424 in response to an inquiry from a guest about an unseated table. Each server 400 determines whether or not reservation can be accepted on the basis of the table status data stored on the fixed disk 424 of the server 400 in response to reservation request from a guest and if acceptable, a reservation number and a reserved table are transmitted to the client computer 800 or the portable telephone 900.

According to a restaurant management system relating to the present embodiment, with configurations as described above, unoccupied seat information can be inquired from a computer and a portable telephone through a network. Furthermore, a reservation can be made from a computer and a portable telephone on the basis of unoccupied seat information of a restaurant. A waiting time imposed on a guest can be reduced when the guest visits a restaurant where an unoccupied seat ratio is higher and can be further reduced by making a reservation in advance. As a result, a restaurant management system can be provided in which a waiting time till table setting is finished after a guest's arrival at a restaurant can be reduced to the shortest possible level with a smallest possible number of employees.

Although the present invention has been described and illustrated in detail, it is clearly understood that the same is by way of illustration and example only and is not be taken by way of limitation, the spirit and scope of the present invention being limited by the terms of the appended claims.

What is claimed is:

1. A server used in a management system for serving food and beverage in a restaurant with a plurality of tables and serving a guest with cooked food and beverage which system comprises: said server; a serving terminal and a plurality of order terminals, wherein an order terminal is placed on each table, being inputted with order information expressing an ordered food item by said guest and transmits said inputted order information to said server; and said serving terminal transmits completion information indicating completion of cooking and inputted by an employee of said restaurant to said server and receives warning information to order information from said server and displays it, comprising:
a communication circuit performing communication with said plurality of order terminals and said serving terminal and
a control circuit connected to said communication circuit and controlling said communication circuit, wherein said control circuit comprises: a circuit detecting a time point at which order information is received from an order terminal; and
a circuit transmitting warning information to said serving terminal that a predetermined time has elapsed till said completion information is received from said serving terminal after said order information was received.

2. The server according to claim 1, wherein said serving terminal receives said order information from said server and displays it and said control circuit further comprises: a circuit transmitting said order information received from said order terminal to said serving terminal.

3. The server according to claim 1, wherein said management system further comprises: a kitchen terminal installed in a kitchen and said kitchen terminal displays said warning information to said order information received from said server, and
said control circuit further comprises: a circuit transmitting said warning information to said kitchen terminal.

4. The server according to claim 1, further comprises: a storage circuit storing a predetermined time for each of kinds of said ordered food items.

5. The server according to claim 1, wherein said order terminal displays an average cooking time of said ordered food item according to said average cooking time received from said server, and wherein
said control circuit further comprises:
a circuit detecting a time point at which said control circuit receives said completion information from said serving terminal;
a circuit calculating a new average value of cooking times on the basis of a passage time till said completion information is received after said order information is received for each of kinds of said ordered food items; and
a circuit transmitting said new average value to said order terminal.

6. The server according to claim 1, wherein said management system further comprises: an occupied seat display terminal, said order terminal further comprises a receipt circuit receiving a charge on said ordered food item and transmits that receipt of a charge by said receipt circuit can be effected to said server prior to transmission of said order information, said occupied seat display terminal displays an occupied seat state at said each table on the basis of occupied seat information received from said server, and
said control circuit further comprises: a circuit responding to information that receipt of a charge can be effected by said receipt circuit to transmit occupied seat information indicating that said each table is seated to said occupied seat display terminal.

7. The server according to claim 1, wherein said order terminal transmits limit information for calculating an amount of money that a guest can use at said each table to said server prior to transmission of said order information,
said serving terminal displays warning information to a balance received from said server,
said server further comprises: a storage circuit storing a price of said ordered food item, and
said control circuit further comprises:
a circuit calculating an amount of money that a guest can use on the basis of said limit information received from said order terminal for said each table;
a circuit reading out a price of said ordered food item from said storage circuit according to said order information received; and
a circuit transmitting warning information to a balance at said each table to said serving terminal when an amount of money obtained by subtracting a price of said ordered food item read out from an amount of money that said guest can use is less than a predetermined amount of money.

8. The server according to claim 1, further comprising:
an external communication circuit communicating with an external terminal installed outside of said restaurant; and
a storage circuit storing information,
wherein said guest transmits reservation request information to said server using said external terminal to obtain reservation information from said server,
said order terminal, when said reservation information that said guest has obtained through said external terminal has been inputted, transmits said reservation information to said server, and, when having received reception information from said server in response to said reservation information, transmits said inputted order information to said server, and
said control circuit comprises:
a circuit generating reservation information corresponding to reservation request information in response to that said external communication circuit has received said reservation request information from said external terminal and forces said storage circuit to store said reservation information;
a circuit transmitting said reservation information to said external terminal;
a circuit responding to that said communication circuit has received reservation information from said order terminal to compare said reservation information received with reservation information stored in said storage circuit; and
a circuit transmitting reception information to said order terminal, if both of said reservation information coincide with each other.

9. The server according to claim 6, further comprising:
an external communication circuit communicating with an external terminal installed outside of said restaurant; and
a storage circuit storing information,
wherein said guest transmits an occupied seat inquiry information to said server using said external terminal to obtain occupied seat information from said server, and
said control circuit comprises:
a circuit forcing said storage circuit to store said occupied seat information; and
a circuit responding to that said external communication circuit has received occupied seat inquiry information from said external terminal to transmit said occupied seat information stored in said storage circuit to said external terminal.

10. An order terminal used in a management system for serving food and beverage in a restaurant with a plurality of tables and serving a guest with cooked food and beverage which system comprises: a serving terminal and a plurality of order terminals, wherein said serving terminal displays said order information received from said order terminal and completion information indicating completion of cooking and inputted by an employee of said restaurant, being placed on each table, and comprising:
an input circuit inputting order information expressing an ordered food item by said guest; and
a transmit circuit connected to said input circuit transmitting said order information to said serving terminal.

11. An order terminal used in a management system for serving food and beverage in a restaurant with a plurality of tables and serving a guest with cooked food and beverage which system comprises: a server; a serving terminal and a plurality of order terminals, wherein said serving terminal transmits completion information indicating completion of cooking and inputted by an employee of said restaurant to said server, said server transmits warning information that a predetermined time has elapsed till said completion information is received from said serving terminal after said order information was received from said order terminal to said serving terminal which displays said warning information to said order information received from said server, being placed on each table and comprising:
a communication circuit communicating with said server;
an input circuit inputting order information expressing an ordered food item by said guest; and
a control circuit connected to said communication circuit and said input circuit controlling said communication circuit and said input circuit, said control circuit including a circuit transmitting said order information to said server.

12. The order terminal according to claim 11, wherein said server calculates a new average value of cooking times on the basis of a passage time till said completion information is received after said order information is received for each of kinds of said ordered food items and transmits said new average value to said order terminal,
further comprising:
a storage circuit storing said new average value received from said server;
a display circuit displaying said new average value; and
a display control circuit controlling said display circuit, wherein
said display control circuit of said order terminal comprises:
a circuit reading out an average value of a cooking time of an ordered food item inputted from an input circuit of said order terminal from storage circuit; and
a circuit controlling a display circuit of said order terminal so as to display said average value read out.

13. The order terminal according to claim 11, wherein said management system further comprises: an occupied seat display terminal, said server responds to that receipt of charge can be effected by a receipt circuit of said order terminal to transmit occupied seat information indicating that said each table is seated to said occupied seat display terminal, which displays an occupied seat state of said each table according to occupied seat information received from said server, further comprising:
a receipt circuit receiving a charge on said ordered food item, and wherein
said control circuit further comprises; a circuit transmitting the fact that receipt of a charge by said receipt circuit can be effected to said server prior to transmission of said order information.

14. The order terminal according to claim 13, wherein said receipt circuit comprises:
a support section capable of mounting a predetermined storage medium thereon and supporting said storage medium mounted;
a processing circuit performing charge processing by inputting/outputting information on said storage medium supported by said support section, wherein
said order terminal further comprises: a receipt control circuit releasing said storage medium from support by said support section after receipt of said charge has been finished.

15. The order terminal according to claim 11, wherein said server calculates an amount of money that a guest can use on the basis of said limit information received from said order terminal for each table and transmits warning information on a balance at said each table to said serving terminal when an amount of money obtained by subtracting a price of said ordered food item from said calculated amount of money that said guest can use is less than a predetermined amount of money, and said serving terminal displays warning information to said balance received from said server, further comprising:
a receipt circuit receiving a charge on said ordered food item, and wherein said control circuit further comprises: a circuit transmitting limit information for calculating an amount of money that a guest can use at said each table prior to transmission of said order information.

16. The order terminal according to claim 11, wherein said guest transmits said reservation request information to said server using said external terminal installed outside of said restaurant to obtain reservation information from said server,
said server responds to that said server has received reservation request information from said external terminal to not only generates reservation information corresponding to said reservation request information but also store said reservation information and transmit said reservation information to said external terminal; and responds to the fact that said server has received said reservation information that said guest has obtained from said order terminal through said external terminal to transmit said reception information to said order terminal if said reservation information received and said reservation information stored coincide with each other,
said order terminal further comprises: a reservation input circuit inputting said reservation information by said guest, and
said control circuit comprises:
a circuit transmitting reservation information inputted from said reservation input circuit to said server; and
a circuit responding to said reservation information and when said communication circuit has received said reception information from said server, transmitting order information inputted from said input circuit to said server.

17. A serving terminal used in a management system for serving food and beverage in a restaurant with a plurality of tables and serving a guest with cooked food and beverage which system comprises: a serving terminal and a plurality of order terminals, wherein an order terminal is placed on each table, inputted with order information expressing an ordered food item by said guest and transmits said inputted order information to said serving terminal comprising:
a receive circuit receiving said order information from said order terminal;
a display circuit displaying information;
an input circuit inputting completion information indicating completion of cooking of said ordered food item by an employee of said restaurant; and
a control circuit connected to said receive circuit, said display circuit and said input circuit controlling said receive circuit, said display circuit and said input circuit, wherein
said control circuit comprises:
a circuit controlling said display circuit so as to display said order information received from said order terminal; and
a circuit controlling said display circuit so as to display said completion information inputted using an input circuit of said serving terminal.

18. A serving terminal used in a management system for serving food and beverage in a restaurant with a plurality of tables and serving a guest with cooked food and beverage which system comprises: a server; said serving terminal and a plurality of order terminals, wherein said order terminal is placed on each table, being inputted with order information expressing an ordered food item by said guest and transmits said inputted order information to said server, said server transmits warning information to said serving terminal that a predetermined time has elapsed till completion information is received from said serving terminal after said order information was received from said order terminal,
comprising:
a communication circuit communicating with said server;
a display circuit displaying information;
an input circuit inputting completion information indicating completion of said ordered food item by an employee of said restaurant; and
a control circuit connected to said communication circuit, said display circuit and said input circuit, and controlling said communication circuit, said display circuit and said input circuit, wherein
said control circuit of said serving terminal comprises:
a circuit transmitting said completion information inputted using said input circuit of said serving terminal to said server; and
a circuit controlling said display circuit so as to display said warning information received from said server.

19. The serving terminal according to claim 18, wherein said server transmits said order information received from said order terminal to said serving terminal and
said control circuit of said serving terminal further comprises: a control circuit controlling said display circuit so as to display said order information received from said server.

20. The serving terminal according to claim 18, wherein said order terminal transmits limit information for calculating an amount of money that a guest can use at said each table prior to transmission of said order information,
said server calculates an amount of money that a guest can use on the basis of said limit information received from said order terminal for said each table and transmits warning information to a balance at said each table to said serving terminal when an amount of money obtained by subtracting a price of said ordered food item from said amount of money that said guest can use is less than a predetermined amount of money, and
said control circuit of said serving terminal further comprises:
a circuit controlling said display circuit so as to display said warning information to said balance received from said server.

21. A kitchen display terminal used in a management system for serving food and beverage in a restaurant with a plurality of tables and serving a guest with cooked food and beverage which system comprises: a server; a serving terminal; a kitchen display terminal; and a plurality of order terminals, wherein said order terminal is placed on each table, being inputted with order information expressing an ordered food item by said guest and transmits said inputted order information to said server, said,, serving terminal transmits completion information indicating completion of cooking and inputted by an employee of said restaurant to said server, and said server transmits warning information to said kitchen terminal that a predetermined time has elapsed till completion information is received from said serving terminal after received said order information was received from said order terminal being installed in said kitchen and comprising:
a communication circuit communicating with said server;
a display circuit displaying information; and
a control circuit connected to said communication circuit and said display circuit controlling said display circuit so as to display said warning information received from said server.

22. An occupied seat display terminal used in a management system for serving food and beverage in a restaurant with a plurality of tables and serving a guest with cooked food and beverage which system comprises: a server; said occupied seat display terminal; and a plurality of order terminals, wherein said order terminal is placed on each table, includes a receipt circuit receiving a charge on an ordered food item, transmits that receipt of said charge can be effected by said receipt circuit to said server, and said server responds to that receipt of said charge can be effected by said receipt circuit of said order terminal to transmit occupied seat information indicating that said each table is seated to said occupied seat display terminal, comprising:
a communication circuit communicating with said server; and
a display circuit connected to said communication circuit and displaying an occupied seat state of said each table on the basis of said occupied seat information received from said server.
